SEQUENCE LISTING (8 sequences)

SEQ ID NO: 1 - RNA, 18 nt, Homo sapiens
  source 1..18: mol_type = mRNA
gaagaagaggacagcact

SEQ ID NO: 2 - RNA, 18 nt, Homo sapiens
  source 1..18: mol_type = mRNA
tcccattcccaccatcac

SEQ ID NO: 3 - RNA, 20 nt, Homo sapiens
  source 1..20: mol_type = mRNA
cttctggcatcctgttgttg

SEQ ID NO: 4 - RNA, 20 nt, Homo sapiens
  source 1..20: mol_type = mRNA
ggtataaggtggtctggttg

SEQ ID NO: 5 - RNA, 18 nt, Homo sapiens
  source 1..18: mol_type = mRNA
tgagccagcagatcgaga

SEQ ID NO: 6 - RNA, 20 nt, Homo sapiens
  source 1..20: mol_type = mRNA
accagtctccatgttgcaga

SEQ ID NO: 7 - RNA, 20 nt, Homo sapiens
  source 1..20: mol_type = mRNA
ggaaagcatatgcagccaac

SEQ ID NO: 8 - RNA, 20 nt, Homo sapiens
  source 1..20: mol_type = mRNA
ctacagtattgcgggccaga

(19) United States
(12) Patent Application Publication
(10) Pub. No.: US 2026/0062431 A1
(43) Pub. Date: Mar. 5, 2026

(54) SILICON-INCORPORATED HDAC-6 INHIBITOR FOR LIVER AND LUNG FIBROTIC DISORDER

(71) Applicant: Council of Scientific and Industrial Research, New Delhi (IN)

(72) Inventors: Dumbala Srinivasa REDDY, Telangana (IN); Sai Balaji ANDUGULAPATI, Telangana (IN); Laxman Devappa NANDAWADEKAR, Telangana (IN); Ramesh EAGALA, Telangana (IN); Nidhi SHARMA, Telangana (IN); Ganesh ROUTHOLLA, Telangana (IN); Hari Priya SRIPADI, Telangana (IN)

(21) Appl. No.: 19/199,624

(22) Filed: May 6, 2025

(30) Foreign Application Priority Data
Sep. 5, 2024 (IN) 202411067202

(51) Int. Cl. C07F 7/08

(52) U.S. Cl. CPC C07F 7/0816

(57) ABSTRACT

The present invention discloses silicon-incorporated HDAC-6 inhibitors of formula (I) and the process of preparation thereof. The invention further relates to methods of treating a group consisting of idiopathic pulmonary fibrosis, hepatic fibrosis, and other fibrotic disorders such as cardiac, kidney, and skin fibrosis.

### CROSS-REFERENCE TO RELATED APPLICATIONS

This application claims priority to Indian Patent Application number 202411067202 filed Sep. 5, 2024, the entire contents of which are incorporated herein by reference.

### INCORPORATION BY REFERENCE OF SEQUENCE LISTING

This application contains references to amino acid sequences and/or nucleic acid sequences which have been submitted concurrently herewith as the sequence listing file entitled “RCYP.P0073US_SequenceListing.xml,” file size 7,690 bytes, created on May 6, 2025. The aforementioned sequence listing is incorporated herein by reference in its entirety.

### FIELD OF THE INVENTION

The present invention relates to the series of silicon-incorporated HDAC-6 Inhibitor and a process for the preparation thereof. Further, the present invention provides the treatment of conditions selected from a group consisting of idiopathic pulmonary fibrosis, hepatic fibrosis, and other fibrotic disorders such as cardiac, kidney, and skin fibrosis.

### BACKGROUND OF THE INVENTION

Liver fibrosis and NASH are characterized by dysregulated fat and collagen accumulation in the liver that triggers inflammation followed by rigidity. Other than lifestyle modifications, currently, there are no proven therapeutic options for NASH. At least 2-4 percent of people with NAFLD may progress to NASH, which is characterized by increased inflammation, fibrosis, lipids (steatosis), septal bridging, and ballooning, followed by cirrhosis. Unattended NASH leads to liver fibrosis, which may further lead to cirrhosis and irreversible liver damage.

Chronic liver injury, induced by a variety of etiologies, causes recurring tissue damage, culminating in diminished liver regenerating ability and fibrosis, which leads to cirrhosis. Worldwide, 2 million human beings are diagnosed with a liver disorder each year; of them, 1 million patients acquire other hepatic problems and 1 million have complications from cirrhosis (2.2% of fatalities). Alcohol consumption and an increase in the obese population are both contributing to an increase in the incidence of liver fibrosis. The prevalence of mild to moderate liver fibrosis is 2.8% in those over 40 years. Novel antifibrotic medications seek to prevent extracellular matrix protein deposition and/or fibrogenic cell development. Liver transplantation is the only treatment available for the late stages of cirrhosis. There is an urgent need to create or repurpose pharmaceuticals for liver fibrosis (unmet medical need), as there are no FDA-approved treatments for the condition or medications to prevent the progression of liver fibrosis till 2023. Very recently March 2024, the FDA approved Rezdiffra (Resmetirom) for the treatment of adults with noncirrhotic non-alcoholic steatohepatitis (NASH) with moderate to advanced liver scarring (fibrosis), to be used along with diet and exercise. However, novel drugs are needed to meet the treatment demand of fibrotic patients. Currently, liver fibrosis comes under the category of unmet medical need.

Another unmet medical need is Idiopathic pulmonary fibrosis (IPF). IPF is a chronic, progressive lung disease characterized by irreversible scarring and fibrosis of lung tissue. Triggers such as radiation, chemotherapy, environmental exposure, severe infection, and unknown factors can activate inflammation, leading to extracellular matrix deposition, tissue injury, and fibrosis, ultimately resulting in reduced lung function. IPF has a global incidence of 0.09-1.30 per 10,000 people and a prevalence of 0.33-4.51 per 10,000 people and a prevalence of 0.33-4.51 per 10,000 people.

Despite the use of these medications, mortality rates have remained relatively constant, necessitating the development of new therapeutic strategies. Although FDA-approved drugs such as pirfenidone and nintedanib decelerate disease progression they have limited therapeutic efficacy. Because these medications have low efficacy, they require higher dosages, resulting in severe gastrointestinal problems and other side effects.

It was shown (CN115784986A) that HDAC-6 inhibitor (preparation of hydrazides) is able to ameliorate tumors, neurodegenerative diseases (Wilson's disease, spinocerebellar disorder, prion disease, Parkinson's disease, Huntington's disease, amyotrophic Lateral Sclerosis (ALS), amyloidosis, Alzheimer's disease, alexander's disease) nervous system disease, stroke, inflammation or autoimmune diseases. In addition, it was also reported that it may be useful to treat alcoholic liver disease, cystic fibrosis, pick's disease, spinal muscular atrophy, Lewy body dementia, pulmonary fibrosis, etc. However, the proposed compound structure is dissimilar to the current innovation.

Similarly, it was claimed (CN115784986A) that HDAC-6 inhibitors were evaluated for their activity specifically against MV4-11 and JA74.1 cell lines for cytotoxicity analysis. However, there were no data/studies on fibrotic disorders. Another study (WO2020264437A1) demonstrated that a selective HDAC6 inhibitor can reprogram isolated macrophages outside of the body (ex vivo) and polarise them towards the anti-tumour M-1 phenotype. In short, this study describes the HDAC-6 inhibitor's capability in treating cancer.

The article titled, “Scalable Synthesis of Silacyclohexanones and Ready Access to Silicon Building Blocks” reported sila analogues of Tubastatin A which is an HDAC 6 inhibitor but it does not disclose any biological activity data for these compounds.

Overall, prior artwork demonstrated the various preparations of HDAC-6 inhibitors and their therapeutic advantages on cancer.

In view of the ever-growing challenges in treating fibrotic disorders, it is necessary to develop an effective, and efficient drug to address these conditions. Our present invention provides a novel class of HDAC inhibitors that offer a promising therapeutic approach for fibrotic conditions.

### Role of HDAC Inhibitors in IPF and Other Disorders

Histone deacetylase inhibitors (HDACi) are therapeutic compounds used against cancer and many other conditions such as fibrotic disorders. HDAC-8 and HDAC-6 levels were found to be significantly up-regulated in patient samples with IPF. Elevated HDAC8/HDAC6 expressions are especially observed in myofibroblasts, vascular smooth, and bronchiolar epithelial cells in IPF-affected lungs.

Emerging evidence from in vitro and in vivo preclinical trials exhibited that, Histone deacetylase (HDAC) inhibitors (HDAC-8 and HDAC-6) have been shown to have beneficial effects in preventing or reversing fibrogenesis. However, there were no HDACs have been approved for IPF to date.

### OBJECTIVE OF THE INVENTION

The main objective of the present invention is to provide silicon-incorporated HDAC 6 inhibitor of formula (I).

Yet another objective is to provide a process of preparation of these HDAC 6 inhibitor of formula (I)

Another objective of the present invention is to provide silicon-incorporated HDAC 6 inhibitors of formula (I) useful for the treatment of idiopathic pulmonary fibrosis, hepatic fibrosis, and other fibrotic disorders such as cardiac, kidney, and skin fibrosis.

### SUMMARY OF THE INVENTION

Accordingly, the present invention provides a silicon-incorporated HDAC-6 inhibitor compounds of formula (I)
wherein,
n is selected from 0-4;
R₁ is selected from the group consisting of hydrogen, halogen, C₁-C₅ alkyl, C₁-C₅ alkoxy;
R₂ and R₃ are independently selected from the group consisting of C₁-C₃ alkyl, aryl groups;
R₄ is selected from the group consisting of hydroxy, NH₂, C₁-C₁₂ alkyl amine, substituted aryl amine and a mixture thereof.

In one of the embodiments, the present invention discloses that the compounds are selected from the group comprising of:

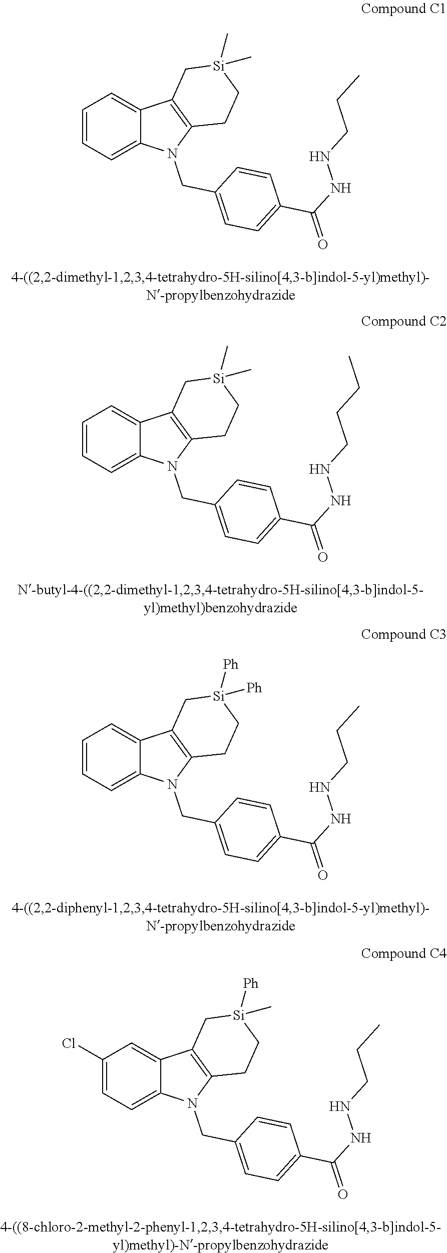

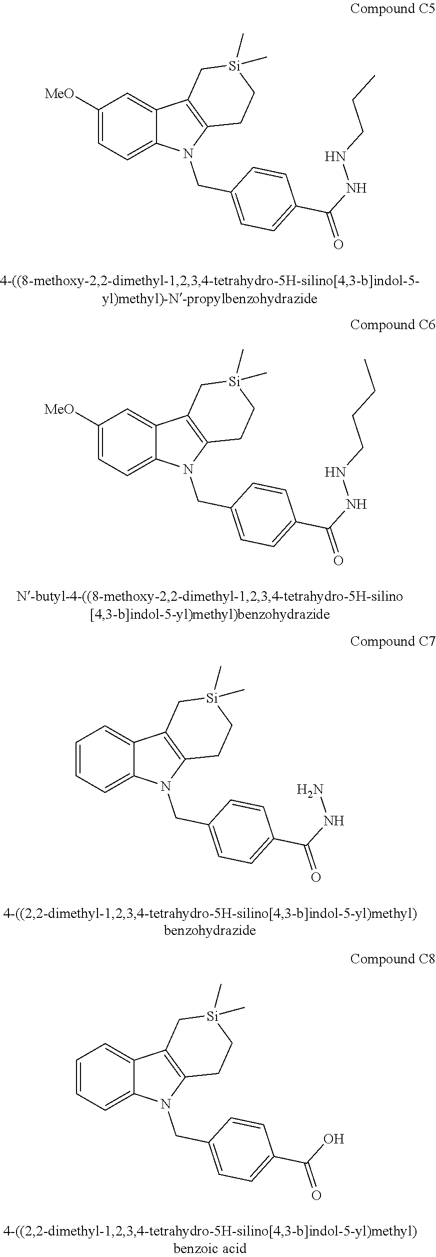

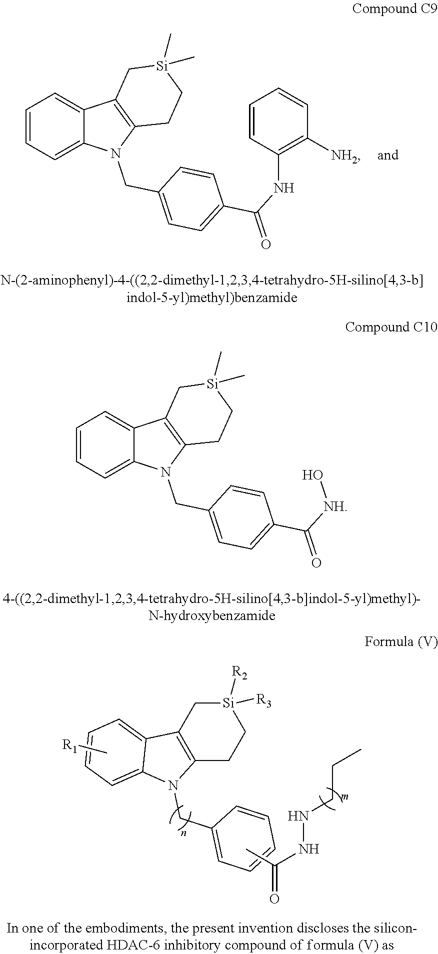

wherein,
n is 0, 1, 2, 3, 4;
m is 1-12;
R₁ is selected from the group consisting of hydrogen, halogen, C₁-C₅ alkyl, and C₁-C₅ alkoxy; and
R₂ and R₃ are independently selected from the group consisting of C₁-C₃ alkyl, aryl groups.

In one of the embodiments, the present invention discloses the silicon-incorporated HDAC-6 inhibitory compound of formula (VIII)

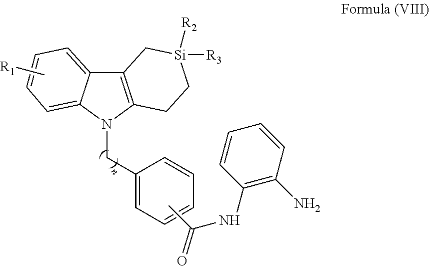

wherein,
n is 0, 1, 2, 3, 4;
R₁ is selected from the group consisting of hydrogen, halogen, C₁-C₅ alkyl, and C₁-C₅ alkoxy; and
R₂ and R₃ are independently selected from the group consisting of C₁-C₃ alkyl, aryl groups.

In yet another aspect, the present invention provides a process for the preparation of silicon incorporation pyridoindole HDAC inhibitory compounds of formula (V) comprising the steps of:
a) reacting the compound of formula (III) with hydrazine hydrate at a temperature of 100° C. for the period of 3 to 5 hrs to obtain compound of formula (IV)

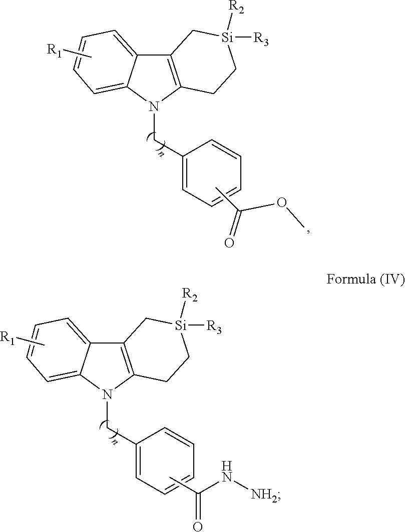

b) reacting compound of formula (IV) obtained in step a) with a C₁-C₁₂ alkyl aldehyde at an ambient temperature period of 2 to 3 hrs following with reducing agents to prepare compound of formula (V)

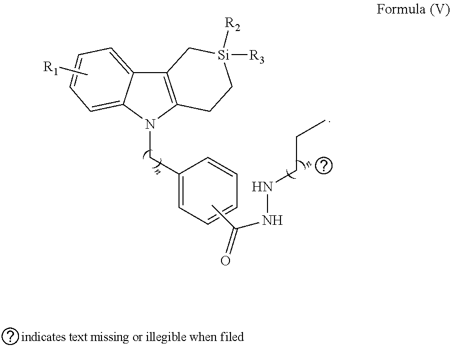

In one of the embodiments, the present invention discloses that the C₁-C₁₂ aldehyde is selected from propionaldehyde, butyraldehyde, pentanal, heptanal, heptaldehyde, octanal, undecanal, dodecanal, benzaldehyde, 3-propylbenzaldehyde, 4-propylbenzaldehyde.

In one of the embodiments, the present invention discloses that the reducing reagent is selected from NaBH₄ (Sodium Borohydride), NaCNBH₄ (Sodium Cyanoborohydride), and Sodium triacetoxyborohydride (STAB).

In yet another aspect, the present invention provides a process for the preparation of silicon incorporation pyridoindole HDAC inhibitory compounds of formula (VIII) comprising the steps of:
a) reacting compound of formula (III) with a base in presence of a polar solvent for a time period of 12-16 hours to produce the compound of formula (VI)

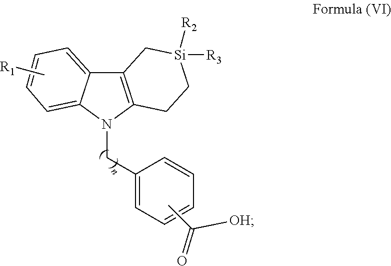

b) compound formula (VI) was treated with substituted aryl amine in presence coupling agent and base in a polar solvent for a time period of 16 hours followed by acid treatment to obtain the compound of formula (VIII)

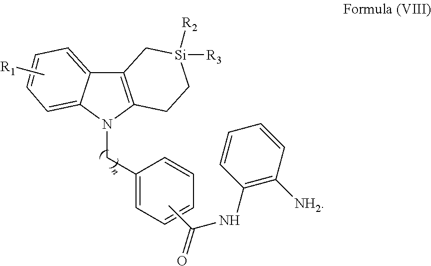

In one of the embodiments, the present invention discloses that the base used to produce the compound of formula (VI) is selected from NaOH (Sodium hydroxide), LiOH (Lithium hydroxide), KOH (Potassium hydroxide)

In one of the embodiments, the present invention discloses that the polar solvent is selected from Methanol, ethanol, THF (Tetrahydrofuran), DMF (Dimethylformamide), Dichloromethane (DCM), aqueous alcohol or mixture thereof.

In one of the embodiments, the present invention discloses that the coupling agent is selected from Hexafluorophosphate Azabenzotriazole Tetramethyl Uronium (HATU), Hydroxybenzotriazole (HOBt), 1-Ethyl-3-(3-dimethylaminopropyl) carbodiimide (EDC. HCl), N,N′-Dicyclohexylcarbodiimide (DCC), Hexafluorophosphate Benzotriazole Tetramethyl Uronium (HBTU), Propanephosphonic acid anhydride (T₃P).

In one of the embodiments, the present invention discloses that the base used to produce the compound of formula (VIII) is selected from Diisopropylethylamine (DIPEA), Triethyl amine TEA, and 4-(N,N-Dimethylamino)pyridine (DMAP) or a mixture thereof.

In one of the embodiments, the present invention discloses that the acid is selected from HCl (Hydrochloric acid), TFA (Trifluoroacetic acid), Methanesulfonic acid (MSA), and para-toluene sulfonic acid (PTSA) or a mixture thereof.

In one of the embodiments, the present invention discloses that the substituted aryl amine is selected from Aniline, 2-amino Aniline, 3-amino aniline, 4-amino aniline, 2-Aminophenol, 4-aminophenol, 4-Nitroaniline, 2-Nitroaniline 4-Aminobenzonitrile, 2-Aminobenzonitrile, 3-Aminobenzonitrile, 3-Ethylaniline, 3-Fluoroaniline, 3-Bromooaniline, 2,5-Dibromoaniline, 2-methoxy Aniline, 4-Methoxyaniline.

In one of the embodiments, the present invention discloses the use of silicon incorporation pyridoindole HDAC inhibitory compounds and isomer, derivative, racemate, analogue and/or pharmaceutically acceptable salt form for preparation of different drugs/APIs/alkaloids.

In one of the embodiments, the present invention discloses that the silicon incorporation pyridoindole HDAC inhibitory compounds and isomer, derivative, racemate, analogue and/or pharmaceutically acceptable salt form are therapeutic agent for treating idiopathic pulmonary, hepatic, cardiac, kidney, and skin fibrosis.

### BRIEF DESCRIPTION OF THE DRAWINGS

FIG. 1: depicts the cell viability of HSC-LX2 cells with HDAC-6 inhibitors (compound-1-5): HSC-LX2 cells were treated with various HDAC-6 inhibitors (compound 1-5) for 36 hrs and subjected to Sulphorhodamine assay and cell viability was calculated using GraphPad Prism software 9.0.

FIG. 2: depicts the cell viability of HSC-LX2 cells with HDAC-6 inhibitors (compound-6-11): HSC-LX2 cells were treated with various HDAC-6 inhibitors (compound 6-11) for 36 hrs and subjected to Sulphorhodamine assay and cell viability was calculated using GraphPad Prism software 9.0.

FIG. 3: depicts the Western-Blot analysis of fibrotic markers expression with HDAC-6 inhibitors (5 μM concentration) in HSC-LX2 cells: HSC-LX2 cells were stimulated with TGF-β and treated with various HDAC-6 inhibitors (Compound C1, C7, C2, C6, C10 and C11) for 36 hrs and subjected to Western-blot analysis for specified markers.

FIG. 4: depicts the collagen 1α1 expression with HDAC-6 inhibitors (5 μM concentrations) in HSC-LX2 cells: HSC-LX2 cells were stimulated with TGF-β and treated with various HDAC-6 inhibitors (Compound C1, C7, C2, C6, C10 and C11) for 36 hrs and subjected to Western-blot analysis for specified markers. Expression of collagen 1α1 was quantified using Image J software.

FIG. 5: depicts the MMP2 expression with HDAC-6 inhibitors (5 μM concentrations) in HSC-LX2 cells: HSC-LX2 cells were stimulated with TGF-β and were treated with various HDAC-6 inhibitors (Compound C1, C7, C2, C6, C10 and C11) for 36 hrs and subjected to Western-blot analysis for specified markers. Expression of MMP-2 was quantified using Image J software.

FIG. 6: depicts a Western-blot analysis of fibrotic markers expression with HDAC-6 inhibitors (with various concentrations) in HSC-LX2 cells: HSC-LX2 cells were stimulated with TGF-β and were treated with various HDAC-6 inhibitors (C1, C2, C6, C10 and C11, in two concentrations) for 36 hrs and subjected to Western-blot analysis for specified markers.

FIG. 7: depicts the collagen 1α1 expression with HDAC-6 inhibitors (with various concentrations) in HSC-LX2 cells: HSC-LX2 cells were stimulated with TGF-β and were treated with various HDAC-6 inhibitors (C1, C2, C6, C10 and C11, in two concentrations) for 36 hrs and subjected to Western-blot analysis for specified markers. Expression of collagen 1α1 was quantified using Image J software.

FIG. 8: depicts the MMP2 expression with HDAC-6 inhibitors (with various concentrations) in HSC-LX2 cells: HSC-LX2 cells were stimulated with TGF-β and were treated with nintedanib (standard drug) with various HDAC-6 inhibitors (C1, C2, C6, C10 and C11, in two concentrations) for 36 hrs and subjected to Western-blot analysis for specified markers. Expression of MMP-2 was quantified using Image J software.

FIG. 9: depicts Western-blot analysis of fibrotic markers expression with HDAC-6 inhibitors (Compound C3, C4, C5, C8 and C9 at 5 μM) in HSC-LX2 cells: HSC-LX2 cells were stimulated with TGF-β and were treated with Nintedanib (NIN) and HDAC-6 inhibitors (Compound C3, C4, C5, C8 and C9 at 5 μM) for 36 hrs and subjected to Western-blot analysis for specified markers.

FIG. 10: depicts the collagen 1α1 expression with HDAC-6 inhibitors (Compound C3, C4, C5, C8 and C9 at 5 μM) in HSC-LX2 cells: HSC-LX2 cells were stimulated with TGF-β and were treated with various HDAC-6 inhibitors (Compound C3, C4, C5, C8 and C9 at 5 μM) for 36 hrs and subjected to Western-blot analysis for collagen 1α1. Expression of collagen 1α1 was quantified using Image J software.

FIG. 11: depicts the MMP2 expression with HDAC-6 inhibitors (Compound C3, C4, C5, C8 and C9 at 5 μM) in HSC-LX2 cells: HSC-LX2 cells were stimulated with TGF-β and were treated with various HDAC-6 inhibitors (Compound C3, C4, C5, C8 and C9 at 5 μM) for 36 hrs and subjected to Western-blot analysis for MMP2. Expression of MMP2 was quantified using Image J software.

FIG. 12: depicts a Western-blot analysis of fibrotic markers expression with HDAC-6 inhibitors (C1, C2 and C11) in HSC-LX2 cells: HSC-LX2 cells were stimulated with TGF-β and were treated with nintedanib (standard drug), C1, C2 HDAC-6 inhibitors (in two concentrations) and C11 for 36 hrs and subjected to Western-blot analysis for specified markers.

FIG. 13: depicts the collagen 1α1 expression with HDAC-6 inhibitors (C1, C2 and C11) in HSC-LX2 cells: HSC-LX2 cells were stimulated with TGF-β and were treated with nintedanib (standard drug), C1, C2 HDAC-6 inhibitors (in two concentrations) and C11 for 36 hrs and subjected to Western-blot analysis for specified markers. Expression of collagen 1α1 was quantified using Image J software.

FIG. 14: depicts the MMP-2 expression with HDAC-6 inhibitors (C1, C2 and C11) in HSC-LX2 cells: HSC-LX2 cells were treated with nintedanib (standard drug), C1, C2 HDAC-6 inhibitors (in two concentrations) and C11 for 36 hrs and subjected to Western-blot analysis for specified markers. Expression of MMP2 was quantified using Image J software.

FIG. 15: depicts the FN-1 expression with HDAC-6 inhibitors (C1, C2 and C11): in HSC-LX2 cells: HSC-LX2 cells were stimulated with TGF-β and were treated with, nintedanib (standard drug), C1, C2 HDAC-6 inhibitors (in two concentrations) and C11 for 36 hrs and subjected to Western-blot analysis for specified markers. Expression of FN1 was quantified using Image J software.

FIG. 16: depicts the immunocytochemistry analysis of α-SMA expression with HDAC-6 inhibitors (C2 and C11) in HSC-LX2 cells: HSC-LX2 cells were stimulated with TGF-β and were treated with nintedanib (standard drug), C2-HDAC-6 inhibitors (in two concentrations) and C11 for 36 hrs and subjected to immunocytochemistry analysis for specified markers.

FIG. 17: depicts the α-SMA expression with HDAC-6 inhibitors (C2 and C11) in HSC-LX2 cells: HSC-LX2 cells were stimulated with TGF-β and were treated with nintedanib (standard drug), C2-HDAC-6 inhibitors (in two concentrations) and C11 for 36 hrs and subjected to immunocytochemistry analysis for specified markers. Expression of α-SMA was quantified using Image J software.

FIG. 18: depicts ALT levels with HDAC-6 inhibitors (C1, C2 and C11) in a CCL4-induced fibrosis model: Mice were treated with CCL4 and treated with C1, C2, C11 and PFD for 4 weeks and then ALT levels were measured using bio-analyzer.

FIG. 19: depicts AST levels with HDAC-6 inhibitors (C1, C2 and C11) in a CCL4-induced fibrosis model: Mice were treated with CCL4 and treated with C1, C2, C11 and PFD for 4 weeks and then AST levels were measured using bio-analyzer.

FIG. 20: depicts the liver index with HDAC-6 inhibitors (C1, C2 and C11) in a CCL4-induced fibrosis model: Mice were treated with CCL4 and treated with C1, C2, C11 and PFD for 4 weeks and then liver weights and body weights were measured and liver index was calculated.

FIG. 21: depicts the histology of the liver with HDAC-6 inhibitors (C2 and C11) in a CCL4-induced fibrosis model: Mice were treated with CCL4 and treated with C2, C11 and PFD for 4 weeks and then liver tissues were isolated and subjected to H&E staining.

FIG. 22 depicts the Western-blot analysis of liver tissues with HDAC-6 inhibitors (C2 and C11) in a CCL4-induced fibrosis model: Mice were treated with CCLA and treated with C2, C11 and PFD for 4 weeks and then liver tissues were isolated and subjected to Western-blot analysis using specified markers.

FIG. 23: depicts the Western-blot quantification of liver tissues with HDAC-6 inhibitors (C2 and C11) in a CCL4-induced fibrosis model: Liver fibrosis was induced with CCL4 and treated with C2, C11 and PFD for 4 weeks and then liver tissues were isolated and subjected to using specified markers. Expression of ROCK2, collagen3α1, FN1, α-SMA and TIMP-3 were quantified using Image J software.

FIG. 24: depicts the cell viability of LL29 cells with HDAC-6 inhibitors (compound-1-5). LL29 cells were treated with various HDAC-6 inhibitors (compound 1-5) for 48 hrs and subjected to Sulphorhodamine assay and cell viability was calculated using GraphPad Prism software 9.0.

FIG. 25: depicts the cell viability of LL29 cells with HDAC-6 inhibitors (compound-6-11). LL29 cells were treated with various HDAC-6 inhibitors (compound 6-11) for 48 hrs and subjected to Sulphorhodamine assay and cell viability was calculated using GraphPad Prism software 9.0.

FIG. 26: depicts the α-SMA, collagen 1α1, Timp-1 and FN-1 expression with HDAC-6 inhibitor compound-1 (C1) in TGF-β induced differentiation model: LL29 cells were stimulated with TGF-β and were treated with HDAC-6 inhibitor (C1) for 48 hrs and subjected to RT-qPCR for specified markers.

FIG. 27: depicts the α-SMA, collagen 1α1, Timp-1 and FN-1 expression with HDAC-6 inhibitor compound-2 (C2) in TGF-β induced differentiation model: LL29 cells were stimulated with TGF-β and were treated with HDAC-6 inhibitor (C2) for 48 hrs and subjected to RT-qPCR for specified markers.

FIG. 28: depicts the α-SMA, collagen 1α1, Timp-1 and FN-1 expression with HDAC-6 inhibitor compound-3 (C3) in TGF-β induced differentiation model: LL29 cells were stimulated with TGF-β and were treated with HDAC-6 inhibitor (C3) for 48 hrs and subjected to RT-qPCR for specified markers.

FIG. 29: depicts the α-SMA, collagen 1α1, Timp-1 and FN-1 expression with HDAC-6 inhibitor compound-4 (C4) in TGF-β induced differentiation model: LL29 cells were stimulated with TGF-β and were treated with HDAC-6 inhibitor (C4) for 48 hrs and subjected to RT-qPCR for specified markers.

FIG. 30 depicts the α-SMA, collagen 1α1, Timp-1 and FN-1 expression with HDAC-6 inhibitor compound-5 (C5) in TGF-β induced differentiation model: LL29 cells were stimulated with TGF-β and were treated with HDAC-6 inhibitor (C5) for 48 hrs and subjected to RT-qPCR for specified markers.

FIG. 31: depicts the α-SMA, collagen 1α1, Timp-1 and FN-1 expression with HDAC-6 inhibitor compound-6 (C6) in TGF-β induced differentiation model: LL29 cells were stimulated with TGF-β and were treated with HDAC-6 inhibitor (C6) for 48 hrs and subjected to RT-qPCR for specified markers.

FIG. 32: depicts the α-SMA, collagen 1α1, Timp-1 and FN-1 expression with HDAC-6 inhibitor compound-7 (C7): LL29 cells were stimulated with TGF-β and were treated with HDAC-6 inhibitor (C7) for 48 hrs and subjected to RT-qPCR for specified markers.

FIG. 33: depicts the α-SMA, collagen 1α1, Timp-1 and FN-1 expression with HDAC-6 inhibitor compound-8 (C8) in TGF-β induced differentiation model: LL29 cells were stimulated with TGF-β and were treated with HDAC-6 inhibitor (C8) for 48 hrs and subjected to RT-qPCR for specified markers.

FIG. 34: depicts the α-SMA, collagen 1α1, Timp-1 and FN-1 expression with HDAC-6 inhibitor compound-9 (C9) in TGF-β induced differentiation model: LL29 cells were stimulated with TGF-β and were treated with HDAC-6 inhibitor (C9) for 48 hrs and subjected to RT-qPCR for specified markers.

FIG. 35: depicts the α-SMA, collagen 1α1, Timp-1 and FN-1 expression with HDAC-6 inhibitor compound-10 (C10) in TGF-β induced differentiation model: LL29 cells were stimulated with TGF-β and were treated with HDAC-6 inhibitor (C10) for 48 hrs and subjected to RT-qPCR for specified markers.

FIG. 36: depicts the α-SMA, collagen 1α1, Timp-1 and FN-1 expression with HDAC-6 inhibitor compound-11 (C11) in TGF-β induced differentiation model: LL29 cells were stimulated with TGF-β and were treated with HDAC-6 inhibitor (C11) for 48 hrs and subjected to RT-qPCR for specified markers.

FIG. 37: depicts the histology of the lung tissues with HDAC-6 inhibitors (C1, C2 and C11) in a bleomycin-induced lung fibrosis model: Mice were treated with bleomycin (BLM) and treated with C1, C2, C11 and PFD for 4 weeks and then lung tissues were isolated and subjected to H&E staining.

FIG. 38: depicts the gene expression analysis of the lung tissues with HDAC-6 inhibitor (C1) in a bleomycin-induced lung fibrosis model: Mice were treated with bleomycin (BLM) and treated with C1 and PFD for 4 weeks and then lung tissues were isolated and subjected to RT-qPCR analysis.

FIG. 39: depicts the Western-blot analysis of lung tissues with HDAC-6 inhibitors (C1 and C11) in a bleomycin-induced lung fibrosis model: Mice were treated with bleomycin (BLM) and treated with C1, C11 and PFD for 4 weeks and then lung tissues were isolated and subjected to Western-blot analysis for specified markers.

FIG. 40: depicts the protein expression (quantification) of the lung tissues with HDAC-6 inhibitors (C1 and C11) in a bleomycin-induced lung fibrosis model: Mice were treated with bleomycin (BLM) and treated with C1, C11 and PFD for 4 weeks and then lung tissues were isolated and subjected to western-blot analysis for specified markers. Expression of FN1, COLLAGEN1α1, VIMENTIN, MMP-2 TIMP-3, α-SMA and TGF-β were quantified using Image J software.

FIG. 41: depicts scheme 1 for preparation of novel silicon-incorporated HDAC inhibitors of formula (V).

FIG. 42: depicts scheme 2 for preparation of novel silicon-incorporated HDAC inhibitors of general formula (VIII).

### DETAILED DESCRIPTION OF THE INVENTION

The invention will now be described in detail in connection with certain preferred and optional embodiments, so that various aspects thereof may be more fully understood and appreciated.

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of elements or steps but not the exclusion of any other element or step or group of elements or steps.

Liver fibrosis is a condition where scar tissue forms in the liver due to chronic injury, often from factors like viral infections (such as hepatitis), alcohol abuse, or non-alcoholic fatty liver disease (NAFLD). As the liver attempts to repair itself, excess collagen builds up, which can disrupt liver function over time. In the early stages, fibrosis may not show obvious symptoms, but if left untreated, it can progress to cirrhosis, liver failure, or liver cancer.

Idiopathic pulmonary fibrosis (IPF) is a chronic and progressive lung disease characterized by the thickening and scarring (fibrosis) of lung tissue, which makes it difficult for the lungs to function properly. The cause of IPF is unknown, hence the term “idiopathic.” Over time, the scarring worsens, leading to symptoms such as shortness of breath, a dry cough, and fatigue. The exact mechanisms behind the fibrosis are not fully understood, but it is thought to involve abnormal healing processes in the lung after injury. IPF primarily affects older adults and tends to worsen gradually, leading to respiratory failure.

HDAC (histone deacetylase) inhibitors are compounds that block the activity of histone deacetylases, enzymes involved in regulating gene expression. HDAC inhibitors play a significant role in managing various disorders by modulating gene expression and influencing cellular processes like inflammation, fibrosis, and cell growth. HDAC inhibitors have emerged as a potential therapeutic strategy for idiopathic pulmonary fibrosis (IPF) due to their ability to regulate gene expression and reduce fibrosis. HDACs play a role in controlling the remodeling of the extracellular matrix, inflammation, and fibrosis in the lungs. In IPF, abnormal activation of these processes contributes to the progressive scarring of lung tissue. By inhibiting HDACs, these compounds can potentially reduce the fibrotic response, modulate inflammatory pathways, and restore normal lung function. In cancer, they can activate tumor suppressor genes and promote cancer cell death, with some already approved for use in certain cancers. In neurodegenerative diseases like Alzheimer's and Parkinson's, HDAC inhibitors may enhance neuroprotective gene expression and reduce toxic protein buildup. Additionally, they show promise in treating cardiovascular diseases by mitigating cardiac fibrosis and in autoimmune disorders by modulating immune responses and reducing chronic inflammation.

In the view of above present invention relates to novel silicon-incorporated HDAC-6 inhibitors of general formula (I) and the process of preparation thereof. The present invention also provides a method for the treatment of fibrotic disorder.

In an embodiment, the present invention provides novel silicon-incorporated HDAC-6 inhibitors of general formula (I)

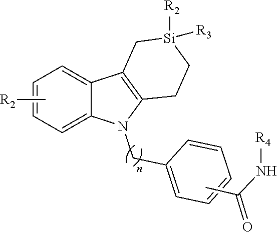

wherein the said formula (I)
n is selected from 0-4;

R₁ is selected from the group consisting of hydrogen, halogen, C₁-C₅ alkyl, C₁-C₅ alkoxy;
R₂ and R₃ are independently selected from the group consisting of C₁-C₃ alkyl, aryl groups;
R₄ is selected from the group consisting of hydroxy, NH₂, C₁-C₁₂ alkyl amine, substituted aryl amine and a mixture thereof.

In another embodiment of the present invention, n can be selected as 0, 1, 2, 3, 4.

In yet another embodiment of the present invention, the proposed work defines a series of molecules and their biological screening studies that have been seen to exhibit significant therapeutic effects against idiopathic pulmonary fibrosis (IPF) and liver fibrosis.

In a preferred embodiment, the compound of general formula (I) is selected from the group consisting of
i. 4-((2,2-dimethyl-1,2,3,4-tetrahydro-5H-silino[4,3-b]indol-5-yl)methyl)-N′-propylbenzohydrazide: Compound C1
ii. N′-butyl-4-((2,2-dimethyl-1,2,3,4-tetrahydro-5H-silino[4,3-b]indol-5-yl)methyl)benzohydrazide: Compound C2
iii. 4-((2,2-diphenyl-1,2,3,4-tetrahydro-5H-silino[4,3-b]indol-5-yl)methyl)-N′-propylbenzohydrazide: Compound C3
iv. 4-((8-chloro-2-methyl-2-phenyl-1,2,3,4-tetrahydro-5H-silino[4,3-b]indol-5-yl)methyl)-N′-propylbenzohydrazide: Compound C4
v. 4-((8-methoxy-2,2-dimethyl-1,2,3,4-tetrahydro-5H-silino[4,3-b]indol-5-yl)methyl)-N′-propylbenzohydrazide: Compound C5
vi. N′-butyl-4-((8-methoxy-2,2-dimethyl-1,2,3,4-tetrahydro-5H-silino[4,3-b]indol-5-yl)methyl)benzohydrazide: Compound C6
vii. 4-((2,2-dimethyl-1,2,3,4-tetrahydro-5H-silino[4,3-b]indol-5yl)methyl)benzohydrazide: Compound C7
viii. 4-((2,2-dimethyl-1,2,3,4-tetrahydro-5H-silino[4,3-b]indol-5-yl)methyl)benzoic acid: Compound C8
ix. N-(2-aminophenyl)-4-((2,2-dimethyl-1,2,3,4-tetrahydro-5H-silino[4,3-b]indol-5-yl)methyl)benzamide: Compound C9
x. 4-((2,2-dimethyl-1,2,3,4-tetrahydro-5H-silino[4,3-b]indol-5-yl)methyl)-N-hydroxy benzamide: Compound C10

In yet another aspect, the present invention provides a process for the preparation of HDAC 6 inhibitors of formula (V), comprising the steps:
a) reacting the compound of formula (III) with hydrazine hydrate at a temperature of 100° C. for the period of 3 to 5 hrs to obtain compound of formula (IV)

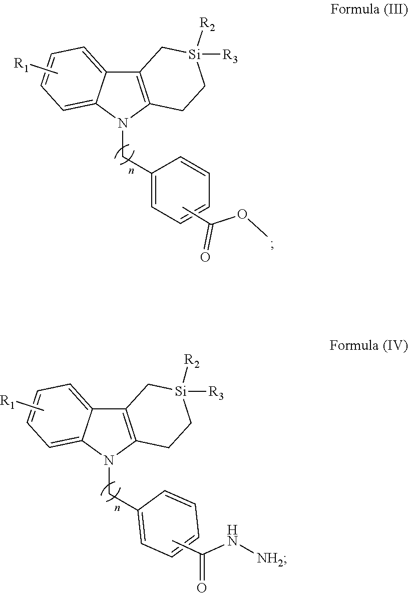

b) reacting compound of formula (IV) obtained in step a) with a C₁-C₁₂ alkyl aldehyde at an ambient temperature period of 2 to 3 hrs following with reducing agents to prepare compound of formula (V)

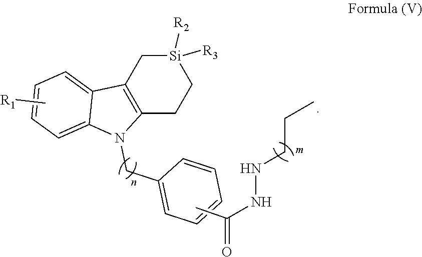

In yet another aspect, the present invention provides a process for the preparation of HDAC 6 inhibitors of formula (VIII), comprising the steps:
a) reacting compound of formula (III) with a base in presence of a polar solvent for a time period of 12-16 hours to produce the compound formula (VI)

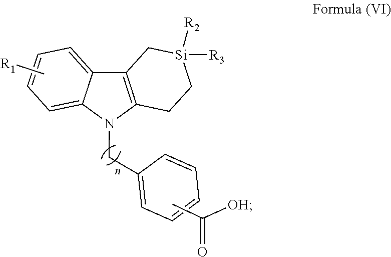

b) compound formula (VI) was treated with substituted aryl amine in presence coupling agent and base in a polar solvent for a time period of 16 hours followed by acid treatment to obtain the compound formula (VIII)

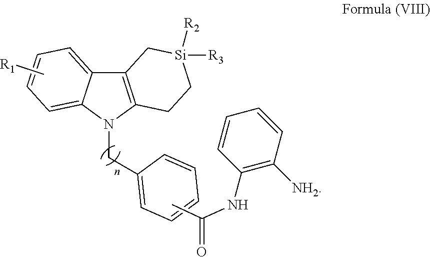

In one of the embodiments, the present invention discloses that the C₁-C₁₂ aldehyde is selected from, but not limited to, propionaldehyde, butyraldehyde, pentanal, heptanal, heptaldehyde, octanal, undecanal, dodecanal, benzaldehyde, 3-propylbenzaldehyde, 4-propylbenzaldehyde.

In one of the embodiments, the present invention discloses that the reducing reagent is selected from, but not limited to, NaBH₄ (Sodium Borohydride), NaCNBH₄ (Sodium Cyanoborohydride), and Sodium triacetoxyborohydride (STAB).

In one of the embodiments, the present invention discloses that the substituted aryl amine is selected from, but not limited to, Aniline, 2-amino Aniline, 3-amino aniline, 4-amino aniline, 2-Aminophenol, 4-aminophenol, 4-Nitroaniline, 2-Nitroaniline 4-Aminobenzonitrile, 2-Aminobenzonitrile, 3-Aminobenzonitrile, 3-Ethylaniline, 3-Fluoroaniline, 3-Bromooaniline, 2,5-Dibromoaniline, 2-methoxy Aniline, 4-Methoxyaniline.

In one of the embodiments, the present invention discloses that the base is selected from, but not limited to, NaOH (Sodium hydroxide), LiOH (Lithium hydroxide), KOH (Potassium hydroxide).

In one of the embodiments, the present invention discloses that the polar solvent is selected from, but not limited to, Methanol, ethanol, THF (Tetrahydrofuran), DMF (Dimethylformamide), DCM (Dichloromethane), aqueous alcohol or mixture thereof.

In one of the embodiments, the present invention discloses that the coupling agent is selected from Hexafluorophosphate Azabenzotriazole Tetramethyl Uronium (HATU), Hydroxybenzotriazole (HOBt), 1-Ethyl-3-(3-dimethylaminopropyl) carbodiimide (EDC. HCl), N,N′-Dicyclohexylcarbodiimide (DCC), Hexafluorophosphate Benzotriazole Tetramethyl Uronium (HBTU), Propanephosphonic acid anhydride (T₃P).

In one of the embodiments, the present invention discloses that the acid is selected from, but not limited to, from HCl (Hydrochloric acid), TFA (Trifluoroacetic acid), Methanesulfonic acid (MSA), and para-toluene sulfonic acid (PTSA) or a mixture thereof.

In yet another aspect, the present invention provides a process for the preparation of HDAC inhibitors of formula (V), comprising the steps:
a) Refluxing a reaction mixture of Silacyclohexanones and substituted and unsubstituted phenyl hydrazine hydrochloride and CAN (Cerium (IV) ammonium nitrate) in a solvent MeOH at a temperature of 100° C. for the period of 1 to 2 hrs to obtain a corresponding compound of formula (II)

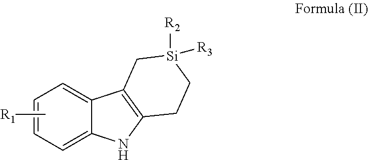

b) Adding of methyl 4-(bromoalkyl)benzoate to a solution of compound of formula (II) and base NaH at 0° C. to room temperature for a period in the range of 1 to 2 hrs, to obtain corresponding N alkylated compound of formula (III)

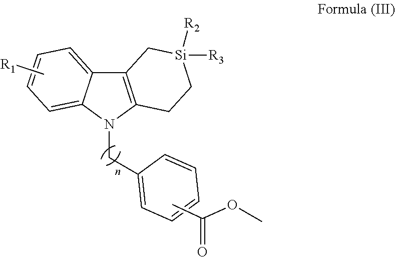

c) Boiling a reaction mixture of Hydrazine hydrate and a solution of compound of formula (III) obtained from step (b) in a solvent at a temperature of 100° C. for the period of 3 to 5 hrs to obtain corresponding formula (IV)

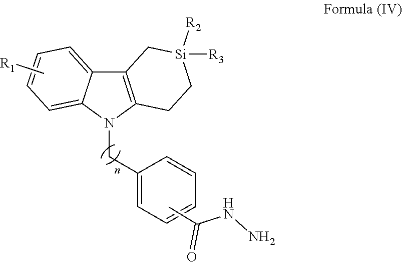

d) Reacting compound of formula (IV) with a C1-C12 alkyl aldehyde in the presence of MeOH:DCM (2:1) at a temperature in the range of 30 to 40° C. for the period of 2 to 3 hrs. Concentrated under vacuum, the resulting mixture reacted with NaBH₄ and solvent at a temperature in the range of 80 to 90° C. for the range of period 1 to 2 hrs to obtain compounds of Formula (V)

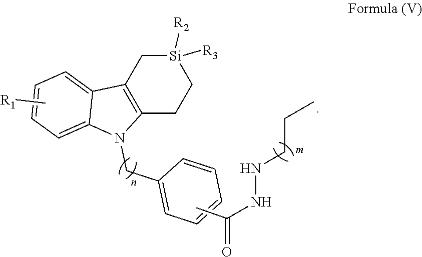

Yet another embodiment of the present invention relates to a process for preparing the compound of formula (VI) comprising the following steps:
a) To obtain the corresponding compound of formula (VI), add 2M NaOH to the solution of the compound of formula (III) obtained from step (b). Stir the mixture at a temperature between 30 to 40° C. for a period of 12 to 16 hours.

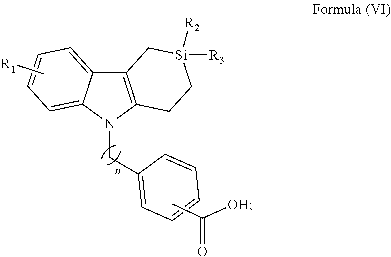

Still, another embodiment is a method for preparing the compound of formula (VII) is presented in this invention, consisting of the following steps:
b) Reacting compound of formula (III) with the aqueous hydroxylamine solution and NaCN in a solvent at a temperature in the range of 30 to 40° C. for the period of 24 h to get the corresponding compound of formula (VII)

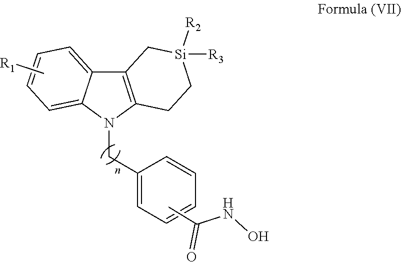

Still, another embodiment of this invention details the method for synthesizing the compound of formula (VIII) through the following steps:
a) Adding EDC·HCl, HOBt, and base DIPEA to a solution of Compound of formula (VI) and different substituted amines in a solvent followed by stirring at a temperature in the range of 30 to 40° C. for the period of 16 hrs further deprotection of the Boc group by acid treatment to get compound of formula (VIII)

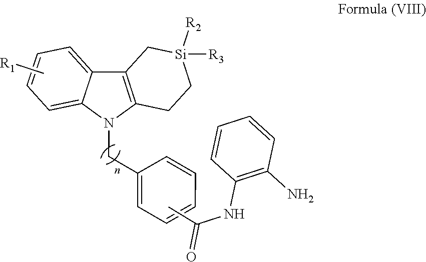

In yet another embodiment of the present invention, the said compound offers a potential lead or drug candidate for the treatment of pulmonary fibrosis. Additionally, this compound may also serve as a lead or drug molecule for the treatment of hepatic fibrosis.

The process of preparation of novel silicon-incorporated HDAC inhibitors of general formula (V) is as depicted in FIG. 41.

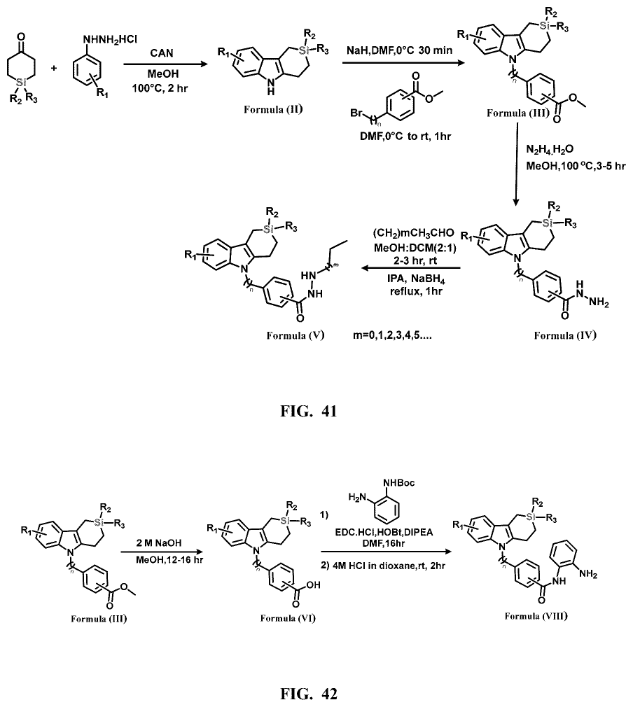

The process of preparation of novel silicon-incorporated HDAC inhibitors of general formula (VIII) is as depicted in FIG. 42.

In an embodiment of the present disclosure, is provided with a silicon-incorporated HDAC-6 Inhibitor compound of general formula (I) as disclosed herein, with the effective dose for use in the treatment of conditions selected from a group consisting of lung inflammatory disorders and fibrotic disorders, wherein the compound significantly attenuated the extracellular matrix proteins and collagen markers expression in TGF-β stimulated LL29 cells.

### EXAMPLES

The following examples, which include preferred embodiments, will serve to illustrate the practice of this invention, it being understood that the particulars shown are by way of example and for the purpose of illustrative discussion of preferred embodiments of the invention.

### General Procedure for the Synthesis of a Compound of Formula (IV):

To a stirred solution of the compound of general formula (III) (1 eq) in MeOH (10 mL), was added Hydrazine hydrate (6 eq) resulting suspension was refluxed for 3 to 5 hours. After which clear solution is cooled at room temperature and concentrated under a vacuum, H₂O (10 mL) is added and extracted with EtOAc (2×20 mL). The combined organic layer was dried over Na₂SO₄, filtered, and concentrated under reduced pressure to get a white solid compound of formula (IV).

### Example 1: Preparation of 4-((2,2-dimethyl-1,2,3,4-tetrahydro-5H-silino[4,3-b]indol-5-yl)methyl)benzohydrazide: Compound C7

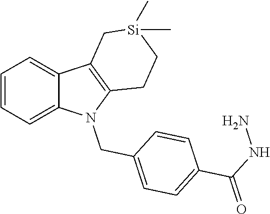 [SMILES: C[Si]1(C)CCc2c(c3ccccc3n2Cc2ccc(C(=O)NN)cc2)C1]

Compound C7 was synthesized from a general procedure used for the synthesis of a compound of formula (III).

White solid, 86% yield; 1H NMR (400 MHz, CDCl₃) δ 7.62 (d, J=8.4 Hz, 2H), 7.59-7.54 (m, 1H), 7.13-7.09 (m, 3H), 6.99 (d, J=8.5 Hz, 2H), 5.30 (s, 2H), 2.84 (t, J=7.1 Hz, 2H), 1.91 (s, 2H), 0.94 (t, J=3.5 Hz, 2H), 0.13 (s, 6H). ¹³C NMR (75 MHz, CDCl₃) δ 168.4, 142.8, 136.6, 136.1, 131.7, 130.1, 127.4, 126.3, 121.4, 119.2, 118.1, 108.6, 108.4, 46.0, 20.3, 9.8, 7.4, −2.8; HRMS, m/z: [M+H]+ Calculated for C₂₁H₂₆N₃OSi 364.1839; Found 364.18323.

### General Procedure for the Synthesis of a Compound of General Formula (V):

In a 100 mL round bottom flask stirred solution of the compound of formula (III) (1 eq) in MeOH:DCM (2:1) was added alkyl aldehyde (1.1 eq) then resulting pale yellow color solution stirred at room temperature for 2 to 3 hr. After this reaction mixture was concentrated under a vacuum. The resulting semi-solid was suspended in IPA (8 mL) and cooled the reaction mixture at 0° C. where NaBH₄ (2 eq) was added and stirred for 10 min, then the suspension was refluxed for 1 h, diluted with H₂O (10 mL) and extracted with CHCl₃ (3×15 mL). The combined organic layer was dried over Na₂SO₄, filtered, and concentrated under reduced pressure to get a crude compound of general formula (I) which was purified by column chromatography using 20-30% EtOAc:Hexane as an eluent to get a pure compound of formula (V).

### Example 2: Preparation of 4-((2,2-dimethyl-1,2,3,4-tetrahydro-5H-silino[4,3-b]indol-5-yl)methyl)N′propylbenzohydrazide: Compound C1

Compound C1 was synthesized from a general procedure used for the synthesis of a compound of formula (V).

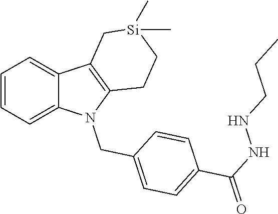 [SMILES: CCCNNC(=O)c1ccc(Cn2c3c(c4ccccc42)C[Si](C)(C)CC3)cc1]

White solid, 79% yield; 1H NMR (400 MHz, CDCl₃) δ 7.62 (d, J=8.3 Hz, 2H), 7.58-7.54 (m, 1H), 7.12-7.09 (m, 3H), 6.99 (d, J=8.2 Hz, 2H), 5.30 (s, 2H), 2.89-2.82 (m, 4H), 1.92 (s, 2H), 1.58-1.49 (m, 2H), 0.97-0.92 (m, 5H), 0.13 (s, 6H). ¹³C NMR (126 MHz, CDCl₃) δ 167.0, 142.6, 136.5, 136.0, 131.9, 130.0, 127.3, 126.2, 121.3, 119.0, 118.0, 108.5, 108.3, 54.1, 45.9, 21.2, 20.2, 11.5, 9.6, 7.3, −3.0 HRMS, [M+H]+ Calculated for C₂₄H₃₂N₃OSi 406.2309; Found 406.2315.

### Example 3: Preparation of N′-butyl-4-((2,2-dimethyl-1,2,3,4-tetrahydro-5H-silino[4,3-b]indol-5-yl)methyl)benzohydrazide: Compound C2

Compound C2 was synthesized from a general procedure used for the synthesis of a compound of formula (V).

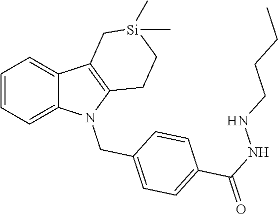 [SMILES: CCCCNNC(=O)c1ccc(Cn2c3c(c4ccccc42)C[Si](C)(C)CC3)cc1]

White solid, 71% yield; 1H NMR (300 MHz, CDCl₃) δ 7.63 (d, J=8.3 Hz, 2H), 7.57-7.54 (m, 1H), 7.12-7.09 (m, 3H), 6.99 (d, J=8.3 Hz, 2H), 5.30 (s, 2H), 2.91 (t, J=7.2 Hz, 2H), 2.84 (t, J=7.0 Hz, 2H), 1.92 (s, 2H), 1.56-1.31 (m, 4H), 0.96-0.90 (m, 5H), 0.13 (s, 6H). ¹³C NMR (101 MHz, CDCl₃) δ 167.0, 142.6, 136.6, 136.1, 132.0, 130.1, 127.4, 126.3, 121.4, 119.1, 118.1, 108.6, 108.4, 52.1, 46.0, 30.2, 20.4, 20.3, 14.1, 9.8, 7.4, −3.0; HRMS, [M+H]+ Calculated for C₂₅H₃₅N₃OSi 420.2465; Found 420.2456.

### Example 4: Preparation of 4-((2,2-diphenyl-1,2,3,4-tetrahydro-5H-silino[4,3-b]indol-5-yl)methyl)-N′-propylbenzohydrazide: Compound C3

Compound C3 was synthesized from a general procedure used for the synthesis of a compound of formula (V).

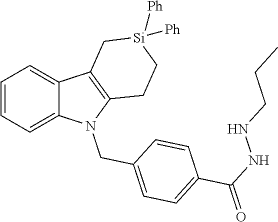 [SMILES: CCCNNC(=O)c1ccc(Cn2c3c(c4ccccc42)C[Si](c2ccccc2)(c2ccccc2)CC3)cc1]

Pale yellow solid, 63% yield; 1H NMR (500 MHz, CDCl₃) δ 7.66-7.63 (m, 1H), 7.57-7.54 (m, 6H), 7.40-7.37 (m, 2H), 7.35-7.32 (m, 4H), 7.16-7.13 (m, 3H), 6.90 (d, J=8.2 Hz, 2H), 5.28 (s, 2H), 2.91-2.87 (m, 4H), 2.52 (s, 2H), 1.57-1.48 (m, 4H), 0.97 (t, J=7.4 Hz, 3H). ¹³C NMR (100 MHz, CDCl₃) δ 166.9, 142.5, 136.7, 136.3, 135.5, 134.7, 131.9, 129.9, 129.7, 128.1, 127.4, 126.2, 121.6, 119.3, 118.3, 108.7, 108.1, 54.2, 46.0, 21.3, 20.4, 11.7, 7.7, 5.4.; LCMS: [M+H]+ Calculated for C₃₄H₃₆N₃OSi 530.75; Found 530.70.

### Example 5: Preparation of 4-((8-chloro-2-methyl-2-phenyl-1,2,3,4-tetrahydro-5H-silino[4,3-b]indol-5-yl)methyl)-N′-propylbenzohydrazide: Compound C4

Compound C4 was synthesized from a general procedure used for the synthesis of a compound of formula (V).

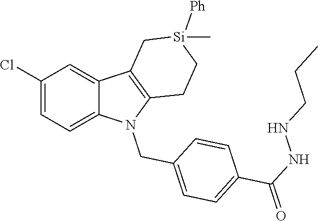 [SMILES: CCCNNC(=O)c1ccc(Cn2c3c(c4cc(Cl)ccc42)C[Si](C)(c2ccccc2)CC3)cc1]

White solid, 67% yield; 1H NMR (400 MHz, CDCl₃) δ 7.61 (d, J=8.3 Hz, 2H), 7.62-7.50 (m, 3H), 7.40-7.31 (m, 3H), 7.08-7.02 (m, 2H), 6.91 (d, J=8.3 Hz, 2H), 5.27 (s, 2H), 2.94-2.76 (m, 4H), 2.24 (d, J=16.8 Hz, 1H), 2.07 (d, J=16.8 Hz, 1H), 1.59-1.50 (m, 2H), 1.24-1.09 (m, 4H), 0.96 (t, J=7.4 Hz, 3H), 0.40 (s, 3H). ¹³C NMR (100 MHz, CDCl₃) δ 166.9, 142.0, 137.8, 137.4, 135.0, 133.8, 132.1, 131.1, 129.5, 128.1, 127.5, 126.2, 125.0, 121.6, 117.9, 109.7, 108.2, 54.2, 46.1, 21.3, 20.4, 11.7, 8.9, 6.2, −4.2.; HRMS, [M+H]+ Calculated for C₂₉H₃₃N₃OClSi 502.2075; Found 502.2082.

### Example 6: Preparation of 4-((8-methoxy-2,2-dimethyl-1,2,3,4-tetrahydro-5H-silino[4,3-b]indol-5-yl)methyl)-N′-propylbenzohydrazide: Compound C5

Compound C5 was synthesized from a general procedure used for the synthesis of a compound of formula (V).

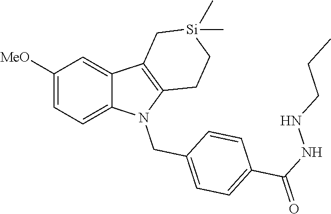 [SMILES: CCCNNC(=O)c1ccc(Cn2c3c(c4cc(OC)ccc42)C[Si](C)(C)CC3)cc1]

White solid, 71% yield; 1H NMR (400 MHz, CDCl₃) δ 7.62 (d, J=8.3 Hz, 2H), 7.04-6.94 (m, 4H), 6.76 (dd, J=8.7, 2.4 Hz, 1H), 5.26 (s, 2H), 3.87 (s, 3H), 2.87 (t, J=7.3 Hz, 2H), 2.82 (t, J=6.9 Hz, 2H), 1.88 (s, 2H), 1.59-1.48 (m, 2H), 0.97-0.88 (m, 5H), 0.13 (s, 6H). ¹³C NMR (101 MHz, CDCl₃) δ 167.0, 154.1, 142.8, 136.9, 131.9, 131.8, 130.5, 127.4, 126.3, 111.0, 109.3, 108.0, 100.6, 56.1, 54.2, 46.1, 21.3, 20.4, 11.8, 9.8, 7.5, −2.9; HRMS, [M+H]+ Calculated for C₂₅H₃₄N₃O₂Si 436.2414; Found 436.2421.

### Example 7: Preparation of N′-butyl-4-((8-methoxy-2,2-dimethyl-1,2,3,4-tetrahydro-5H-silino[4,3-b]indol-5-yl)methyl)benzohydrazide: Compound C6

Compound C6 was synthesized from a general procedure used for the synthesis of a compound of formula (V).

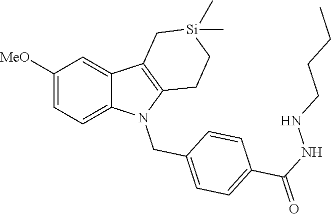 [SMILES: CCCCNNC(=O)c1ccc(Cn2c3c(c4cc(OC)ccc42)C[Si](C)(C)CC3)cc1]

White solid, 73% yield; 1H NMR (400 MHz, CDCl₃) δ 7.62 (d, J=8.3 Hz, 2H), 7.02-6.96 (m, 4H), 6.76 (dd, J=8.7, 2.4 Hz, 1H), 5.26 (s, 2H), 3.87 (s, 3H), 2.90 (t, J=7.2 Hz, 2H), 2.82 (t, J=6.9 Hz, 2H), 1.88 (s, 2H), 1.54-1.33 (m, 4H), 0.95-0.89 (m, 5H), 0.13 (s, 6H). ¹³C NMR (75 MHz, CDCl₃) δ 167.0, 154.1, 142.8, 136.9, 131.9, 131.8, 130.5, 127.4, 126.3, 111.0, 109.3, 108.0, 100.6, 56.1, 52.2, 46.1, 30.2, 20.4, 20.4, 14.0, 9.8, 7.5, −2.9; HRMS, [M+H]+ Calculated for C₂₆H₃₆N₃O₂Si 450.2571; Found 450.2576.

### Example 8: Preparation of 4-((2,2-dimethyl-1,2,3,4-tetrahydro-5H-silino[4,3-b]indol-5-yl)methyl)benzoic acid: Compound C8

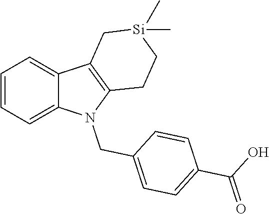 [SMILES: C[Si]1(C)CCc2c(c3ccccc3n2Cc2ccc(C(=O)O)cc2)C1]

To a solution of the compound of formula (III) (1 eq) in MeOH (5 mL) was added 2M NaOH solution (2 eq) then the reaction was stirred at rt for 12 hr, after completion of starting material dilute the reaction with H₂O adjust the PH 4 to 5 by using 1N HCl and extracted with EtOAc (3×10 mL). The combined organic layer was dried over Na₂SO₄, filtered, and concentrated under reduced pressure to get compound C8 as a white solid. yield 84%; 1H NMR (400 MHz, CDCl₃) δ 8.00 (d, J=8.2 Hz, 2H), 7.57-7.54 (m, 1H), 7.14-7.10 (m, 3H), 7.02 (d, J=8.1 Hz, 2H), 5.33 (s, 2H), 2.84 (t, J=6.9 Hz, 2H), 1.92 (s, 2H), 0.94 (t, J=7.0 Hz, 2H), 0.13 (s, 6H). ¹³C NMR (75 MHz, CDCl₃) δ 171.5, 144.8, 136.6, 136.1, 130.8, 130.1, 128.4, 126.1, 121.5, 119.2, 118.2, 108.6, 108.5, 46.1, 20.3, 9.8, 7.4, −3.0; HRMS, m/z: [M+H]+ Calculated for C₂₁H₂₄NO₂Si 350.15708; Found 350.15642.

### Example 9: Preparation of N-(2-aminophenyl)-4-((2,2-dimethyl-1,2,3,4-tetrahydro-5H-silino[4,3-b]indol-5-yl)methyl)benzamide: Compound C9

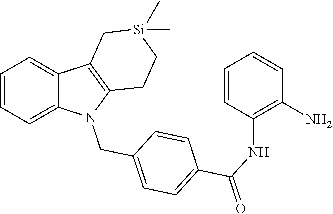 [SMILES: C[Si]1(C)CCc2c(c3ccccc3n2Cc2ccc(C(=O)Nc3ccccc3N)cc2)C1]

In a round-bottom flask, compound C8 was dissolved in DMF (4 mL). To this solution, EDC·HCl (1.2 eq), HOBt (1.2 eq), and DIPEA (3 eq) were added. The reaction mixture was stirred at room temperature for 15 min. Subsequently, Boc-protected amine was added, and the mixture was stirred at room temperature for 16 hr. The reaction mixture was then washed with saturated NaHCO₃ and extracted with EtOAc (2×15 mL) to obtain the Boc-protected compound. This compound was deprotected using 4M HCl in dioxane at room temperature for 2 hours. The mixture was concentrated under vacuum, and the residue was diluted with EtOAc (15 mL) and washed with saturated NaHCO₃ (10 mL). The combined organic layer was dried over Na₂SO₄, filtered, and concentrated under reduced pressure to yield compound C9 as a pale yellow solid, 65% yield: 1H NMR (400 MHz, CDCl₃) δ 7.84 (s, 1H), 7.76 (d, J=8.1 Hz, 2H), 7.60-7.56 (m, 1H), 7.27-7.25 (m, 1H), 7.17-7.10 (m, 3H), 7.09-6.98 (m, 3H), 6.80 (t, J=8.1 Hz, 2H), 5.32 (s, 2H), 2.86 (t, J=7.0 Hz, 2H), 1.93 (s, 2H), 0.96 (t, J=7.0 Hz, 2H), 0.14 (s, 6H). ¹³C NMR (101 MHz, CDCl₃) δ 165.5, 142.7, 140.6, 136.5, 136.0, 133.1, 130.0, 127.8, 127.2, 126.3, 125.2, 124.5, 121.3, 119.8, 119.1, 118.4, 118.0, 108.5, 108.3, 46.0, 20.2, 9.7, 7.3, −3.0; HRMS, m/z: [M+H]+ Calculated for C₂₇H₃₀N₃OSi 440.2152; Found 440.2134.

### Example 10: Preparation of 4-((2,2-dimethyl-1,2,3,4-tetrahydro-5H-silino[4,3-b]indol-5-yl)methyl)-N-hydroxybenzamide: Compound C10

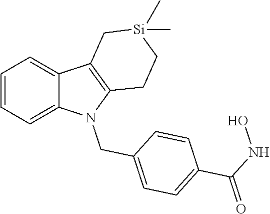 [SMILES: C[Si]1(C)CCc2c(c3ccccc3n2Cc2ccc(C(=O)NO)cc2)C1]

To a solution of intermediate of formula (III) (1.0 eq) in MeOH (10 mL) and THF (4 mL), to this solution 50% aq NH₂OH (4 mL) followed by NaCN (0.2 equiv) was added and stirred at rt for 12 h. Subsequently, the reaction was quenched with water (20 mL) and extracted with (CH₂Cl₂ 2×25 mL). The combined organic layer was dried over Na₂SO₄, filtered, and concentrated under reduced pressure. The crude was purified by column chromatography to afford compound C10, white solid, 71% yield; 1H NMR (400 MHz, DMSO-d6) δ 11.11 (s, 1H), 8.98 (s, 1H), 7.65 (d, J=8.2 Hz, 2H), 7.44 (d, J=7.3 Hz, 1H), 7.30 (d, J=8.0 Hz, 1H), 7.05-6.95 (m, 4H), 5.40 (s, 2H), 2.85 (t, J=6.8 Hz, 2H), 1.83 (s, 2H), 0.90 (t, J=6.9 Hz, 2H), 0.11 (s, 6H); ¹³C NMR (100 MHz, DMSO-d6) δ 163.9, 142.0, 136.2, 136.0, 131.6, 129.4, 127.2, 125.8, 120.8, 118.5, 117.5, 109.0, 107.0, 45.1, 19.6, 9.0, 7.0, −3.1; HRMS [M+H]+ Calculated for C₂₁H₂₃N₂O₂Si 363.1523; Found 363.1527.

### Example 11: Preparation of N-hydroxy-4-((2-methyl-1,2,3,4-tetrahydro-5H-pyrido[4,3-b]indol-5-yl)methyl)benzamide: Compound C11

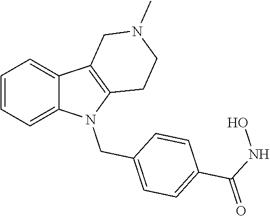 [SMILES: CN1CCc2c(c3ccccc3n2Cc2ccc(C(=O)NO)cc2)C1]

Compound C11 Synthesized by a process disclosed in J Am Chem Soc. 2010, 132, 10842-10846.

### Pan HDAC Inhibition Data:

| | | | PAN |
|---|---|---|---|
| Sr. | | | HDAC |
| No | Compound name | Structure | inhibition (%) |
| 1 | 4-((2,2-dimethyl-1,2,3,4- tetrahydro-5H-silino[4,3- b]indol-5- yl)methyl)N′propylbenzo- hydrazide | 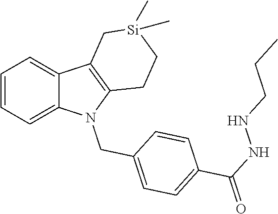 [SMILES: CCCNNC(=O)c1ccc(Cn2c3c(c4ccccc42)C[Si](C)(C)CC3)cc1] | 67% |
| 2 | N′-butyl-4-((2,2-dimethyl- 1,2,3,4-tetrahydro-5H- silino[4,3-b]indol-5- yl)methyl)benzohydrazide | 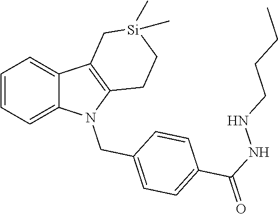 [SMILES: CCCCNNC(=O)c1ccc(Cn2c3c(c4ccccc42)C[Si](C)(C)CC3)cc1] | 35% |
| 3 | 4-((2,2-diphenyl-1,2,3,4- tetrahydro-5H-silino[4,3- b]indol-5-yl)methyl)-N′- propylbenzohydrazide | 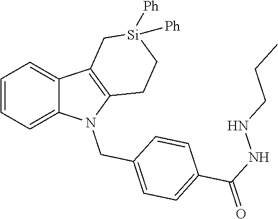 [SMILES: CCCNNC(=O)c1ccc(Cn2c3c(c4ccccc42)C[Si](c2ccccc2)(c2ccccc2)CC3)cc1] | 20% |
| 4 | 4-((8-chloro-2-methyl-2- phenyl-1,2,3,4-tetrahydro- 5H-silino[4,3-b]indol-5- yl)methyl)-N′- propylbenzohydrazide | 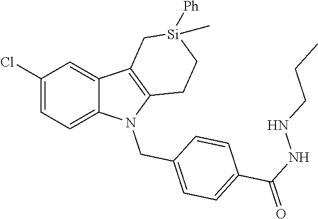 [SMILES: CCCNNC(=O)c1ccc(Cn2c3c(c4cc(Cl)ccc42)C[Si](C)(c2ccccc2)CC3)cc1] | 19% |
| 5 | 4-((8-methoxy-2,2- dimethyl-1,2,3,4- tetrahydro-5H-silino[4,3- b]indol-5-yl) methyl)-N′- propylbenzohydrazide | 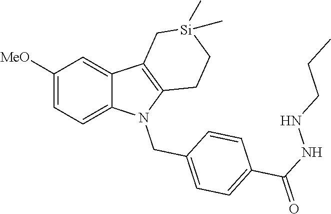 [SMILES: CCCNNC(=O)c1ccc(Cn2c3c(c4cc(OC)ccc42)C[Si](C)(C)CC3)cc1] | 22% |
| 6 | N′-butyl-4-((8-methoxy- 2,2-dimethyl-1,2,3,4- tetrahydro-5H-silino[4,3- b]indol-5- yl)methyl)benzohydrazide | 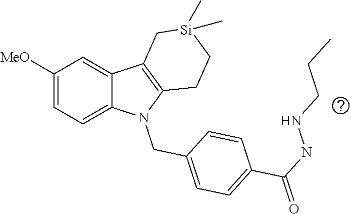 [SMILES: CCCNNC(=O)c1ccc(Cn2c3c(c4cc(OC)ccc42)C[Si](C)(C)CC3)cc1] [symbol] | 20% |
| 7 | 4-((2,2-dimethyl-1,2,3,4- tetrahydro-5H-silino[4,3- b]indol-5- yl)methyl)benzohydrazide | 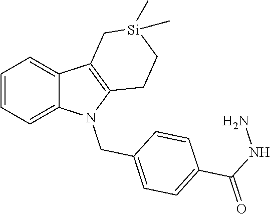 [SMILES: C[Si]1(C)CCc2c(c3ccccc3n2Cc2ccc(C(=O)NN)cc2)C1] | No inhibition |
| 8 | 4-((2,2-dimethyl-1,2,3,4- tetrahydro-5H-silino[4,3- b]indol-5- yl)methyl)benzoic acid | 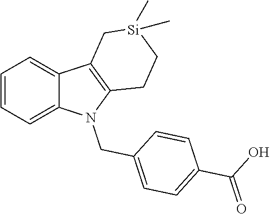 [SMILES: C[Si]1(C)CCc2c(c3ccccc3n2Cc2ccc(C(=O)O)cc2)C1] | No inhibition |
| 9 | N-(2-aminophenyl)-4- ((2,2-dimethyl-1,2,3,4- tetrahydro-5H-silino[4,3- b]indol-5- yl)methyl)benzamide | 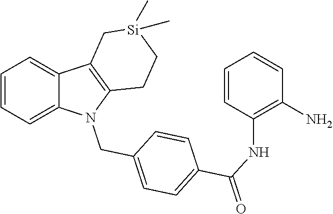 [SMILES: C[Si]1(C)CCc2c(c3ccccc3n2Cc2ccc(C(=O)Nc3ccccc3N)cc2)C1] | 20% |
| 10 | N-hydroxy-4-((2-methyl- 1,2,3,4-tetrahydro-5H- pyrido[4,3-b]indol- 5-yl)methyl)benzamide: (Tubastatin A) | 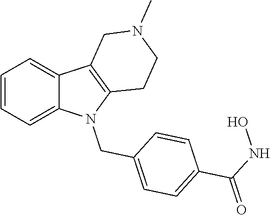 [SMILES: CN1CCc2c(c3ccccc3n2Cc2ccc(C(=O)NO)cc2)C1] | 62% |
| 11 | 4-((2,2-dimethyl-1,2,3,4- tetrahydro-5H-silino[4,3- b]indol-5-yl)methyl)-N- hydroxybenzamide | 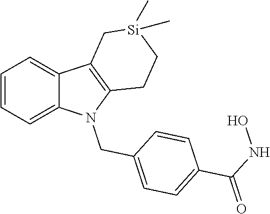 [SMILES: C[Si]1(C)CCc2c(c3ccccc3n2Cc2ccc(C(=O)NO)cc2)C1] | 30% |

[symbol]

indicates data missing or illegible when filed

### Methodology for Biological Assays

### Cell Lines and Cell Culture

LL29 cells (lung fibroblasts from IPF patients) were purchased from ATCC and cultured in Ham's F-12K medium supplemented with 15% FBS. HSC-LX2 cells were purchased from MERCK and cultured in DMEM+2% FBS-containing media. All the cells were maintained in a humidified atmosphere of 95% air with 5% CO₂ at 37° C.

### MTT Assay (Cytotoxicity Assay)

Cells (LL29 and HSC-LX2) were seeded into a 96-well plate (4×10³ cells/well) and cells were treated with HDAC-6 inhibitors (Compound 1-11) which were dissolved in DMSO, in various concentrations (1.25, 2.5 and 5 μM) and DMSO (vehicle control). Further, the cells were incubated for 48 hours. Then, cell percentage of cell death was determined with an MTT (Sigma Aldrich, St Louis, MI) assay. IC₅₀ values were calculated by the curve fit method using GraphPad Prism-9 software.

### TGF-β Stimulation

LL29 cells were serum starved overnight and then cells were stimulated with human recombinant TGF-β (Himedia, India) added at a concentration of 5 ng/mL and treated with various concentrations of HDAC-6 inhibitors for 48 hours and then subjected to RTqPCR or Western-blot analysis.

RNA Isolation, cDNA Synthesis and q-RT-PCR

RNA isolation was carried out using RNA isoplus as described^{12,13}. RNA was isolated using RNA isoplus-chloroform method and total RNA was quantified using nano-drop, 1 μg of RNA was used to convert into cDNA using a primescript cDNA synthesis kit (Takara bio) according to manufacturer's instructions. Primers for EMT (Collagen 1α1 Fibronectin1 (FN1), Timp1, and α-SMA) and housekeeping markers (β2M) were designed using Primer 3 software and all primer sequences were listed in Table 1. Real-time quantitative PCR (RT-qPCR) was carried out using SYBR green master mix and the differences in mRNA expression of all the gene levels were calculated as the fold change using the formula 2-ΔΔct. In all RT-qPCR data plots, vehicle control fold change was normalized to 1.

TABLE 1
Sequences of transcripts/primers human (h) used
for real-time quantitative PCR.
Genes associated with fibrosis

| S. No. | Primer | Forward | Reverse |
|---|---|---|---|
| 1 | h-αSMA | GAAGAAGAGGACAG | TCCCATTCCCACCA |
| | | CACT | TCAC |
| 2 | h-TIMP1 | CTTCTGGCATCCTGT | GGTATAAGGTGGTC |
| | | TGTTG | TGGTTG |
| 3 | h- | TGAGCCAGCAGATC | ACCAGTCTCCATGT |
| | Collagen | GAGA | TGCAGA |
| | 1α1 | | |
| 4 | h-FN 1 | GGAAAGCATATGCA | CTACAGTATTGCGG |
| | | GCCAAC | GCCAGA |

### Western-Blot Analysis:

After stimulation of TGF-β and treatment with HDAC-6 inhibitors, LL29 cells or HSC-LX2 cells were lysed using RIPA lysis buffer and centrifuged at 13000 RPM (at 4° C.) for 15 min. Further, the supernatant was separated for the estimation of protein concentration using a BCA kit as per the user manual. The specified amount (30 μg) of protein sample was loaded onto the gradient SDS-PAGE (8-15%) gel electrophoresis (80V, 2 hrs) and transferred onto polyvinylidene difluoride membranes (20 min). Thereafter blots were kept for blocking using 5% bovine serum albumin for up to 1 hr then the blots were allowed to incubate overnight with primary antibodies (specified) on a dancing shaker at 2-8° C. Further blots were washed three times at 10 min intervals using TBST buffer and incubated by secondary antibody for 1 hr employing continuous shaking, then the blots were developed using ECL reagent and bands were captured using the Fusion imaging system. The densitometric analysis was performed using Image J software.

### Immunocytochemistry (ICC)

HSC-LX2 cells were stimulated with TGF-β and further treated with Compound C2 and C11 (2.5 or 5 μM or both concentrations) for 36 hrs and subjected to ICC as described earlier. In short, cells were fixed, permeabilized and blocked with 1% bovine serum albumin for 1 hr and probed with α-SMA antibody overnight. Further, cells were probed with secondary antibodies and counterstained with DAPI and images were captured using an Olympus microscope and analyzed using Image J software.

### Animal Studies

### CCL4-Induced Liver Fibrosis in Mice Model

Adult male C57BL/6 mice (weighing 20-25 g, n=6) of SPF grade were procured from an authorized CCSEA vendor. In vivo experiments were approved by the Institutional Animal Ethics Committee, CSIR-IICT, Hyderabad (Approval No.: IICT-IAEC-008-2024). All methods were carried out following relevant guidelines and regulations. All mice were housed under a controlled temperature (22-23° C.) and on a 12 h light and 12 h dark cycle with food and water ad libitum. All animals were allowed to adapt to their new housing conditions for one week before the experiments. The mice were randomly divided into 8 groups (n=6 in each group) as follows: control group, CCl4− treated model group, Pirfinidonc-200 mg·kg⁻¹, C1-30 mg·kg⁻¹, C1-60 mg·kg⁻¹, C2-30 mg·kg⁻¹, C2-60 mg·kg⁻¹ and C11-60 mg·kg⁻¹. CCl4− was administered to all animals except sham control group animals, by injecting intraperitoneally with 10% CCl4 (2 ml/kg of body weight) diluted in olive oil every other day for 8 weeks. From the 5th week, the mice were orally administered with pirfenidone (PFD), C1 or C2 or C11 or the same volume of vehicle for 4 weeks. At the end of the animal experiment, mice were fasted overnight. Then blood samples were collected to measure AST and ALT levels further liver tissues were isolated and subjected to western-blot analysis and histopathological assessments.

### Bleomycin-Induced Pulmonary Fibrosis:

Adult male C57BL/6 mice (weighing 20-25 g, n=36) of SPF grade were procured from an authorized CCSEA vendor. In vivo experiments were approved by the Institutional Animal Ethics Committee, CSIR-IICT, Hyderabad (Approval No.: IICT-IAEC-008-2024). Bleomycin-induced pulmonary fibrosis has been developed as previously reported in Inflamm Res. 2024 July; 73 (7): 1223-1237. doi: 10.1007/s00011-024-01894-5. In brief, all the mice except sham control mice received a single intratracheal injection of 2 mg·kg⁻¹ bleomycin (BLM) solution after being sedated with an intraperitoneal injection of Ketamine (80 mg·kg⁻¹)-Xylazine mixture (10 mg·kg⁻¹). Sham control mice were similarly dosed with normal saline. All animals are observed until they recover from sedation. Following 7 days of BLM injection, mice were randomised into 6 groups (n=6/group) namely: Group-1: Sham control (treated with normal saline), Group-2: Disease control (BLM-2 mg·kg⁻¹), Group-3: BLM+pirfenidone-200 mg·kg⁻¹, Group-4: BLM+C1-30 mg·kg⁻¹, Group-5: BLM+C1-60 mg·kg⁻¹ Group-6: BLM+C2-30 mg·kg⁻¹, Group-5: BLM+C2-60 mg·kg⁻¹ and Group-8: BLM+C11-60 mg·kg⁻¹. Further animals were dosed with saline (sham control and disease control groups, orally), pirfenidone (PFD) or C1 or C2 or and C11 (orally) for 14 days. Throughout the experiment, animal body weights and survival of mice were noted. Further, end of the treatment period, the animals were euthanized, lungs were isolated and various lobes of the lungs were separated and collected (for assessing the gene expression and western-blot analysis) and stored in a −80° C. freezer. In addition, one of the lung lobes was excised and immersed in 10% buffered formalin for histopathological assessments.

### Assessment of Lung or Liver Histology

After fixation, tissues were embedded in paraffin cassettes, and 5 μm slices were placed on glass slides for H&E analysis. Microscopic photographs were acquired at 2× or 4× and 20× magnification.

### Results on Liver Fibrosis Model

### Example 12: Assessing the Cell Viability of HDAC-6 Inhibitors in HSC-LX-2 Cells

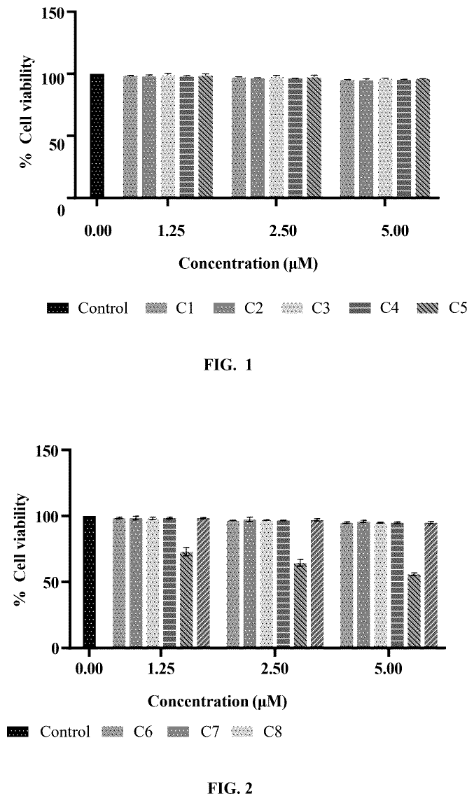

In vitro, the effects of HDAC-6 inhibitors (COMPOUND-1-11) on cell viability were investigated using HSC-LX-2 cells. HSC-LX2 Cells were treated with 1.25, 2.5 and 5 μM of HDAC-6 inhibitors for 36 hrs and then subjected to SRB assay. SRB assay results revealed that treatment with HDAC-6 inhibitor-10 showed 50-55% cell death compared to control. However, all compounds were taken forward for anti-fibrotic markers assessments (FIGS. 1 and 2).

### Example 13: Assessing the Anti-Fibrotic Activity of HDAC-6 Inhibitors (Compound 1, 7, 2, 6, 10 and 11) in Liver Fibrotic Cells Using Western-Blot Analysis

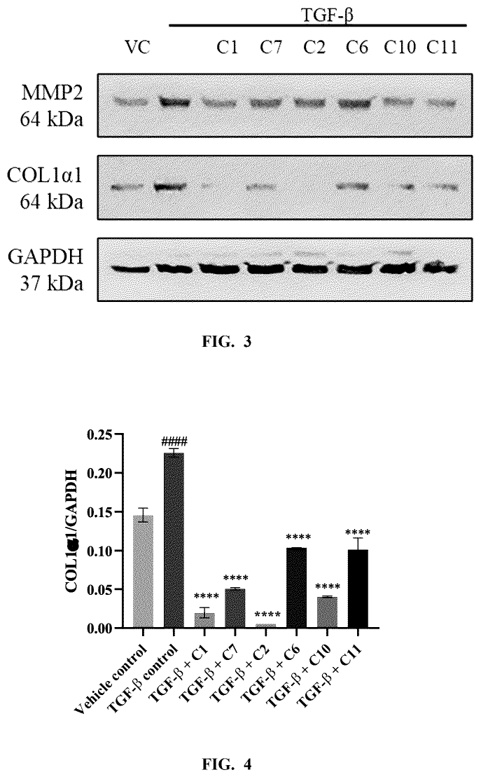

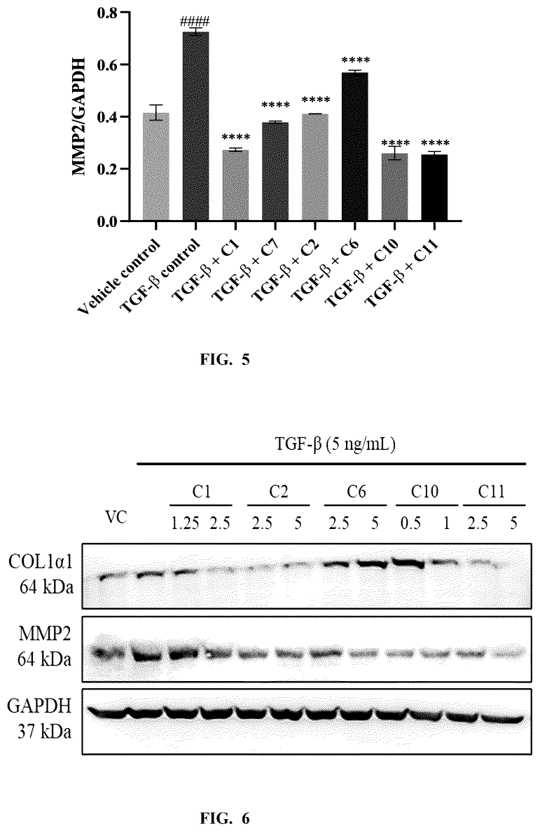

In the current investigation, we have screened silicon-incorporated HDAC-6 inhibitor compounds (compounds 1, 7, 2, 6, 10 and 11) in in vitro models. Here, HSC-LX2 cells (liver fibrotic cells) were stimulated with TGF-β and treated with 5 μM of HDAC inhibitors (each compound) for 36 hrs and subjected to Western-blot analysis. Further, Western-blot analysis revealed that stimulation with TGF-β significantly increased the expression of MMP2 and collagen 1α1 compared to control cells. Moreover, treatment with compounds C1, C7, C2, C6, C10 and C11 significantly reduced the expression of fibrotic markers such as MMP2 and collagen 1α1 compared to TGF-β control cells. However, compounds C1 and C2 showed better collagen 1α1 reduction compared to the remaining compounds (FIG. 3-5).

### Example 14: Assessing the Anti-Fibrotic Activity of HDAC-6 Inhibitors (Compounds 1, 2, 6, 10 and 11) in Liver Fibrotic Cells Using Western-Blot Analysis

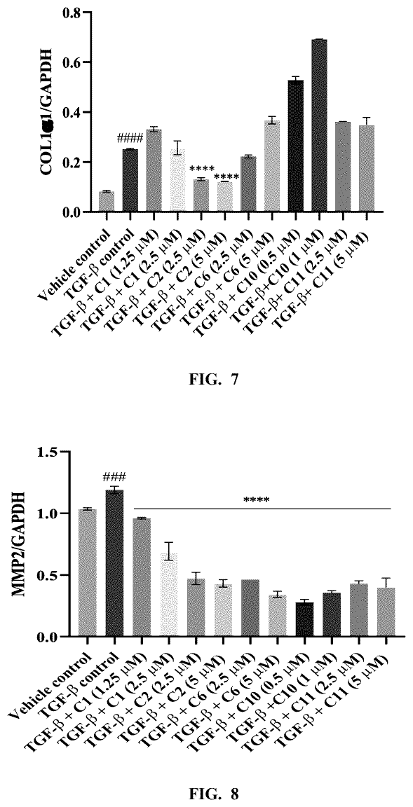

In the current investigation, we have screened silicon-incorporated HDAC-6 inhibitor compounds (compounds 1, 2, 6, 10 and 11) in in vitro models. Here, HSC-LX2 cells (liver fibrotic cells) were stimulated with TGF-β and treated with 5 μM of HDAC inhibitors (each compound) for 36 hrs and subjected to Western-blot analysis. Further, Western-blot analysis revealed that stimulation with TGF-β significantly increased the expression of MMP2 and collagen 1α1 compared to control cells. Moreover, treatment with compounds C1, C2, C6, C10, and C11 significantly reduced the expression of MMP2 marker compared to TGF-β control cells. However, compound C2 only showed significant collagen 1α1 reduction compared to the remaining compounds (FIG. 6-8).

### Example 15: Assessing the Anti-Fibrotic Activity of HDAC-6 Inhibitors (Compounds 3, 4, 5, 8 and 9) in Liver Fibrotic Cells Using Western-Blot Analysis

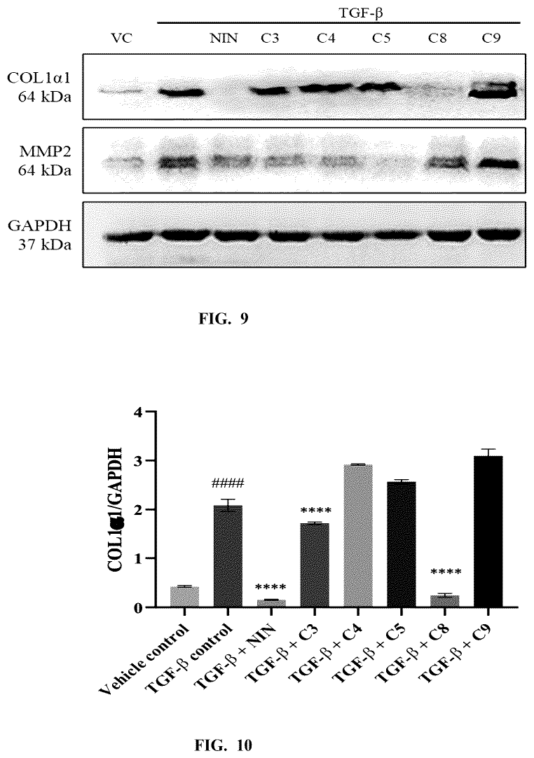

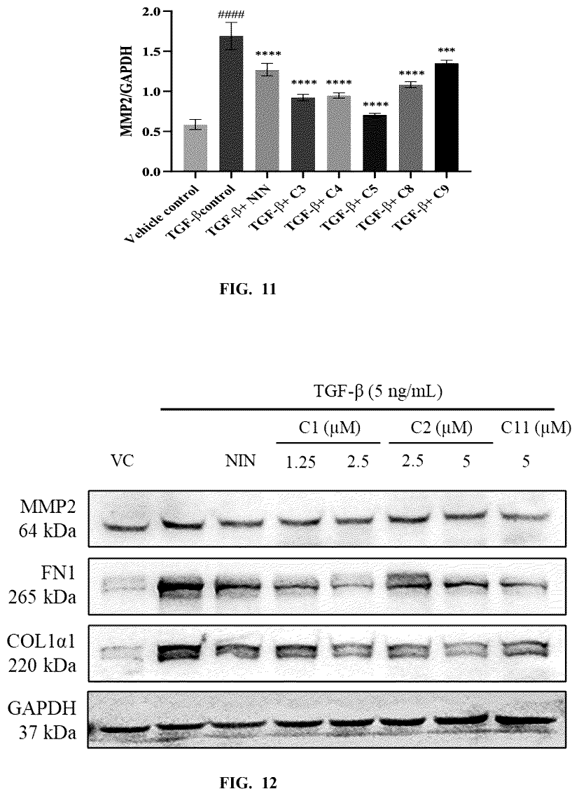

In the current investigation, we have screened silicon-incorporated HDAC-6 inhibitor compounds (compounds 3, 4, 5, 8 and 9) in in vitro models. Here, HSC-LX2 cells (liver fibrotic cells) were stimulated with TGF-β and treated with 5 μM of HDAC inhibitors (each compound) and nintedanib-NIN (1 μM) for 36 hrs and subjected to Western-blot analysis. Further, Western-blot analysis revealed that stimulation with TGF-β significantly increased the expression of MMP2 and collagen 1α1 compared to control cells. Moreover, treatment with compounds C3, C8 and NIN significantly reduced the expression of the MMP2 marker compared to TGF-β control cells. However, all compounds showed significant collagen 1α1 reduction compared to the remaining compounds (FIG. 9-11).

### Example 16: Assessing the Anti-Fibrotic Activity of HDAC-6 Inhibitors (Compound C1, C2 and C11) in Liver Fibrotic Cells Using Western-Blot Analysis

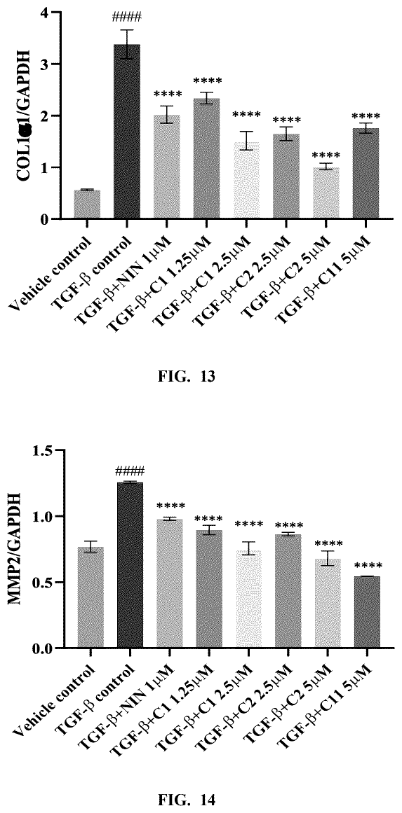

Further, we have assessed the silicon-incorporated HDAC-6 inhibitor compounds (compounds 1, 2, and 11) in in vitro models. Here, HSC-LX2 cells (liver fibrotic cells) were stimulated with TGF-β and treated with 5 μM of HDAC inhibitors (each compound) for 36 hrs and subjected to Western-blot analysis. Further, Western-blot analysis revealed that stimulation with TGF-β significantly increased the expression of MMP2, FN1 and collagen 1α1 compared to control cells. Moreover, the treatment with compounds C1, C2, and C11 significantly reduced the expression of MMP2, FN1 and collagen 1α1 markers compared to TGF-β control cells. However, compound C2 showed better collagen 1α1 reduction compared to the remaining compounds (FIG. 12-15).

### Example 17: Assessing the Anti-Fibrotic Activity of HDAC-6 Inhibitors (Compound C2 and C11) in Liver Fibrotic Cells Using Immunocytochemistry Analysis

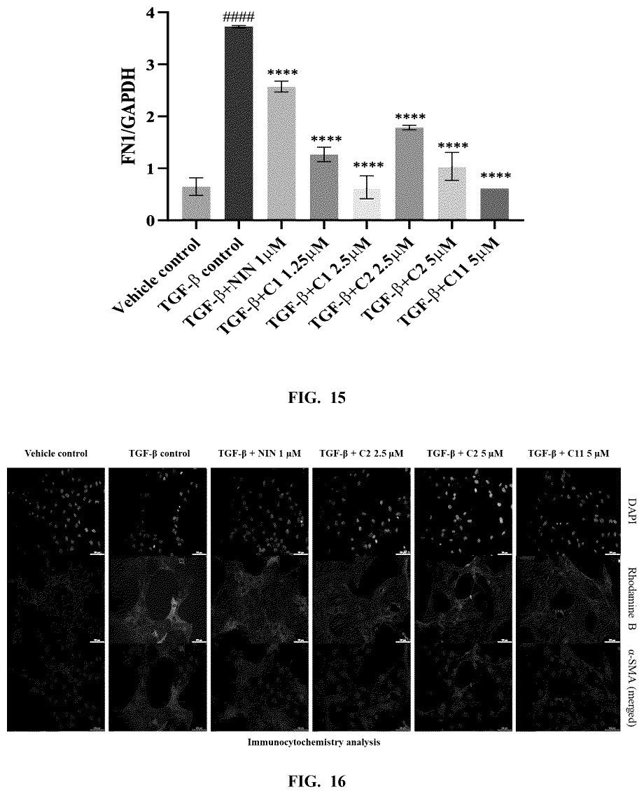

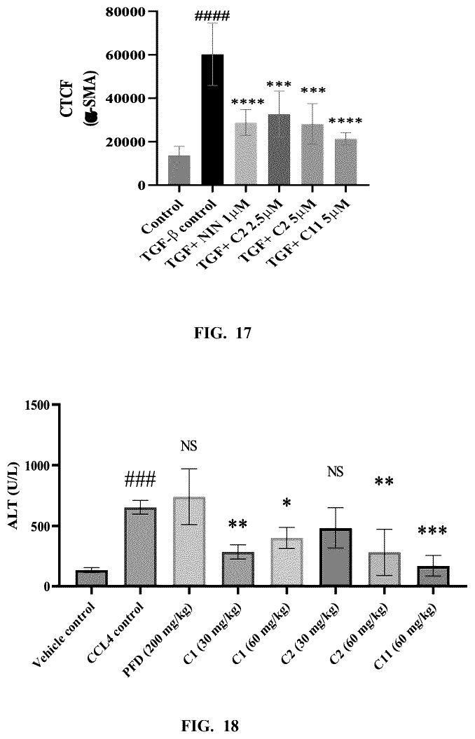

Further, we have assessed the silicon-incorporated HDAC-6 inhibitor compounds (compounds 2, and 11) in in vitro models. Here, HSC-LX2 cells (liver fibrotic cells) were stimulated with TGF-β and treated with 5 μM of HDAC inhibitors (each compound) for 36 hrs and subjected to immunocytochemistry analysis. Further, immunocytochemistry analysis revealed that stimulation with TGF-β significantly increased the expression of α-SMA compared to control cells. Moreover, treatment revealed that compounds C2 and C11 significantly reduced the expression of α-SMA compared to TGF-β control cells. However, compound C2 showed better collagen 1α1 reduction compared to the remaining compounds (FIG. 16-17). Since Compound 1 and Compound 2 have shown better anti-fibrotic activity in in vitro models, these compounds were further taken forward for in vivo assessments using an induced liver fibrosis model in mice.

### Example 18: Assessing the Effect of HDAC-6 Inhibitors (Compound C1, C2 and C11) on Liver Functional Markers in CCL4 Induced Liver Fibrosis Model

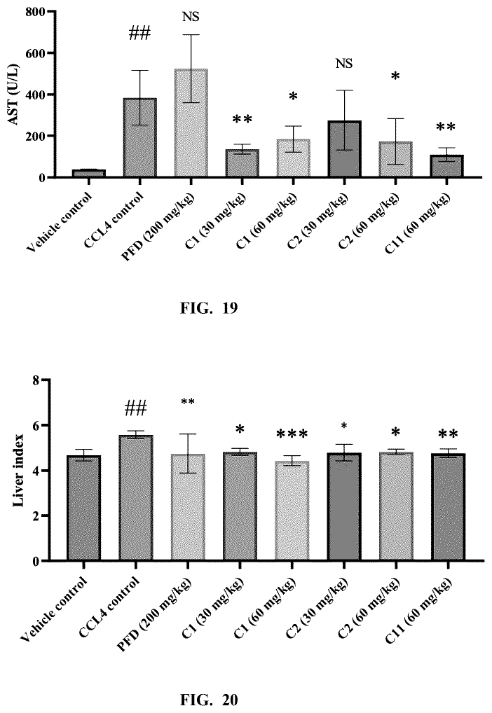

Since Compound 1 and Compound 2 have shown better anti-fibrotic activity in in vitro models, these compounds were further taken forward for in vivo assessments using a CCL4-induced liver fibrosis model in mice. The liver fibrosis model was established by administering the CCL4 in mice for 8 weeks, after 4 weeks of administration of CCL4, treatment with test compounds (C1, C2, C11 and PFD) were initiated and continued till 8 weeks. After 8 weeks, blood samples were collected in fasting condition and subjected to AST and ALT estimation. Biochemical analysis revealed that AST and ALT levels were significantly elevated in the CCL4 control group compared to sham control. Further, we have assessed the effect of silicon-incorporated HDAC-6 inhibitor compounds (compounds C1, C2, and 11) in in vivo models. Treatment with C1, C2 and C11 significantly reduced the AST and ALT levels compared to CCL4 control or PFD control. This data indicates that compounds C1, C2 and C11 ameliorate CCL4-induced inflammation in mouse models (FIG. 18-19).

### Example 19: Assessing the Effect of HDAC-6 Inhibitors (Compound C1, C2 and C11) on CCL4 Induced Histopathological Anomalies in Liver

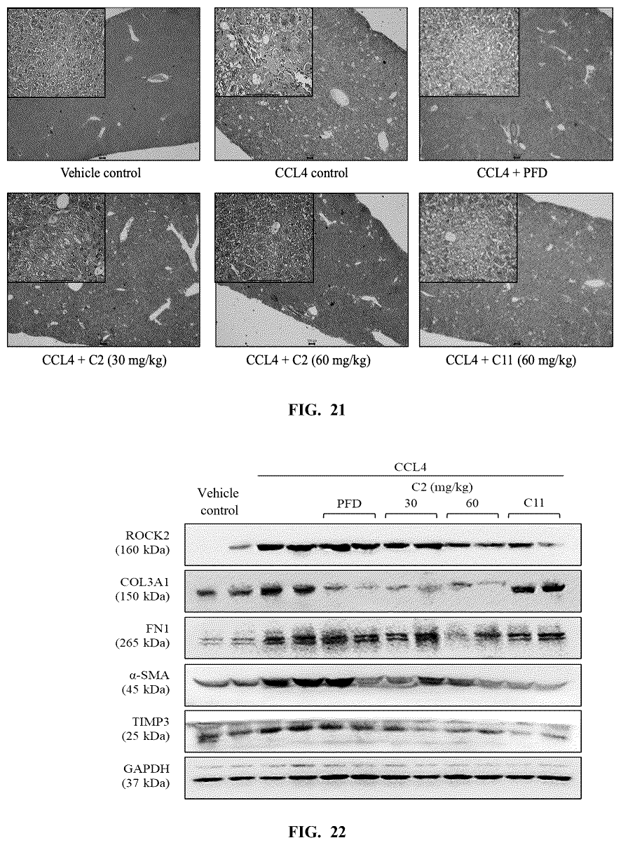

Further, liver tissues were collected from all the groups and weighed individually. Liver weight analysis revealed that treatment with C1 or C2 or C11 significantly reduced the CCL4-induced elevation of liver weights compared to CCL4 control (FIG. 20). Further we investigated whether compound C1 or C2 could relieve liver fibrosis and protect the liver damage from CCL4 toxicity. Hematoxylin and cosin (H&E) staining was used to analyze histological observations in the liver section. The livers of the control group mice had a normal lobular structure with radial hepatic cord and central vein, whereas in the CCL4 control group, necrosis in the center of the hepatic lobules, elevated inflammatory cell infiltration and deposition of lipid droplets in hepatocytes were observed. On the other hand, treatment with C2 remarkably inhibited these pathological changes, as showed by the decrease in hepatocyte degeneration, inflammatory cell accumulation and lipid deposition, indicating that C2 may relieve hepatic fibrosis in CCL4-induced mice. However, Compound C11 failed to reduce the CCL4-induced pathological anomalies (FIG. 21).

### Example 20: Assessing the Anti-Fibrotic Activity of HDAC-6 Inhibitors (Compound C2 and C11) in CCL4 Induced Liver Fibrosis Model

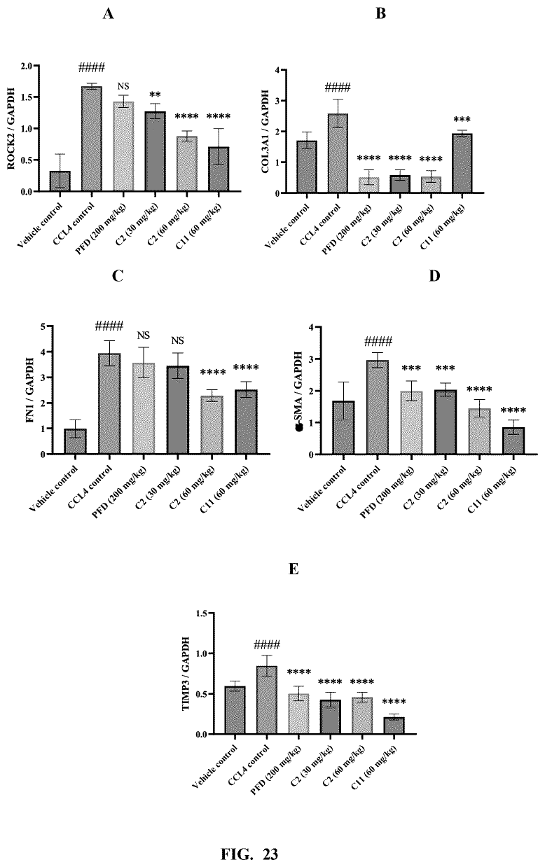

Since histopathological data reveals that, Compound C2 showed better protective effects compared to CCL4 control or C1 or C11, further assays were performed with C2. Next, liver specimens were collected and subjected to western blot analysis, and protein expression results demonstrated that induction with CCL4 significantly increased the expression of fibrotic markers such as ROCK-2, Collagen 3α1, fibronectin (FN1), α-SMA and TIMP-3, in CCL4 control group compared to sham control. On the other hand, treatment with C2 or C11 significantly reduced the CCL4-induced elevation of ROCK-2, TIMP-3, fibronectin (FN1), collagen-3α1 and α-SMA expression compared to CCL4 control. However, Compound C2 reduced the collagen-1α1 expression better than C11. Overall this data demonstrated that compound C2 significantly reduced the fibrotic markers expression compared to C11 or PFD (FIG. 22-23).

### Results on Lung Fibrosis Model

### Example 21: Assessing the Cell Viability of HDAC-6 Inhibitors in LL29 Cells

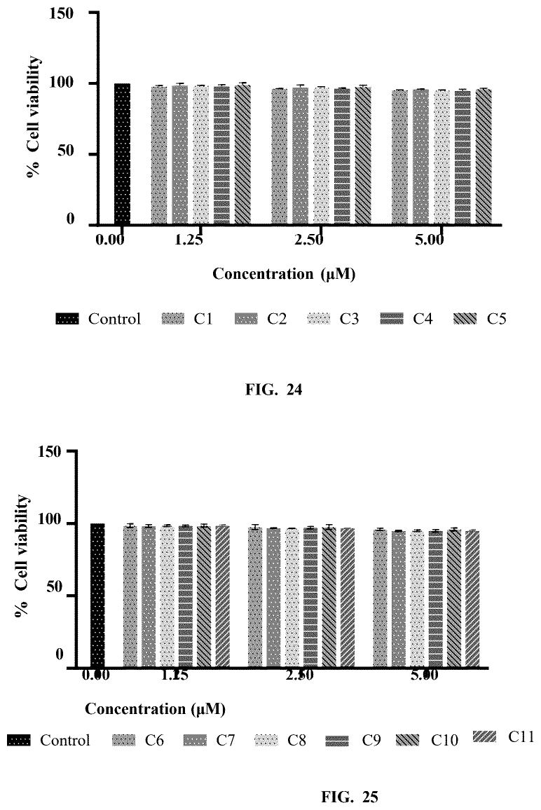

In vitro effects of HDAC-6 inhibitors (COMPOUND-1-11) on cell viability were investigated on LL29 cells; Cells were treated with 1.25, 2.5 and 5 μM of HDAC-6 inhibitors for 48 hrs and then subjected to SRB assay. SRB assay results revealed that treatment with HDAC-6 inhibitors C1 to C11 did not cause any cell death at tested concentrations, therefore all the compounds were taken forward for anti-fibrotic markers assessments (FIGS. 24 and 25).

### Example 22: Assessing the Anti-Fibrotic Activity of HDAC-Inhibitor-C1 in TGF-β Induced Differentiation LL29 Cells

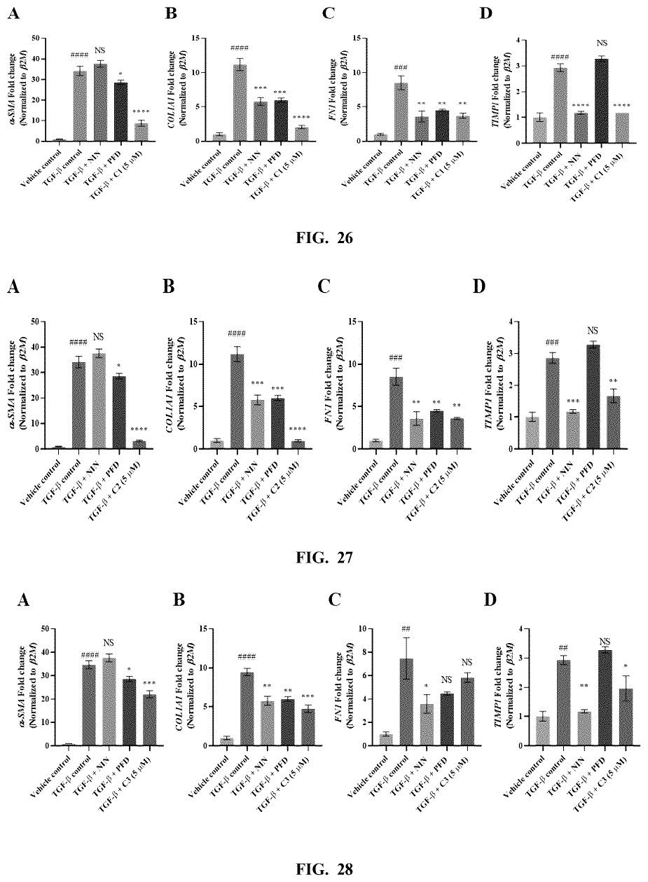

Further, we have assessed the anti-fibrotic activity of silicon-incorporated HDAC-6 inhibitor compound-1 in in vitro lung fibrosis model. Here, LL29 cells (Idiopathic lung fibrotic cells) were stimulated with TGF-β and treated with compound-C1 (5 μM) for 48 hrs and subjected to gene expression analysis. RTqPCR data showed that compound C1 significantly reduced the TGF-β induced expression of α-SMA, collagen-1 al, FN1 and Timp-1 compared to TGF-β control cells. Compared to nintedanib or pirfenidone, compound C1 showed a better reduction (FIG. 26).

### Example 23: Assessing the Anti-Fibrotic Activity of HDAC-Inhibitor-C2 in TGF-β Induced Differentiation LL29 Cells

Further, we have assessed the anti-fibrotic activity of silicon-incorporated HDAC-6 inhibitor compound-2 in in vitro lung fibrosis model. Here, LL29 cells (Idiopathic lung fibrotic cells) were stimulated with TGF-β and treated with compound-C2 (5 μM) for 48 hrs and subjected to gene expression analysis Further, RTqPCR analysis revealed that stimulation with TGF-β significantly increased the expression of α-SMA, collagen-1 al, FN1 and Timp-1 compared to control cells. Moreover, treatment with compound C2 significantly reduced the TGF-β induced expression of α-SMA, collagen-1 α1, FN1 and Timp-1 compared to TGF-β control cells. Compared to nintedanib or pirfenidone, compound C2 showed a better reduction (FIG. 27).

### Example 24: Assessing the Anti-Fibrotic Activity of HDAC-Inhibitor-C3 in TGF-β Induced Differentiation LL29 Cells

Further, we have assessed the anti-fibrotic activity of silicon-incorporated HDAC-6 inhibitor compound-3 in in vitro lung fibrosis model. Here, LL29 cells (Idiopathic lung fibrotic cells) were stimulated with TGF-β and treated with compound-C3 (5 μM) for 48 hrs and subjected to gene expression analysis. RTqPCR analysis revealed that stimulation with TGF-β significantly increased the expression of α-SMA, collagen-1 α1, FN1 and Timp-1 compared to control cells. Moreover, treatment with compound C3 significantly reduced the TGF-β induced expression of α-SMA, collagen-1 al and Timp-1 compared to TGF-β control cells. Compound C3 failed to reduce the expression of FN1 compared to TGF-β control cells (FIG. 28).

### Example 25: Assessing the Anti-Fibrotic Activity of HDAC-Inhibitor-C4 in TGF-β Induced Differentiation LL29 Cells

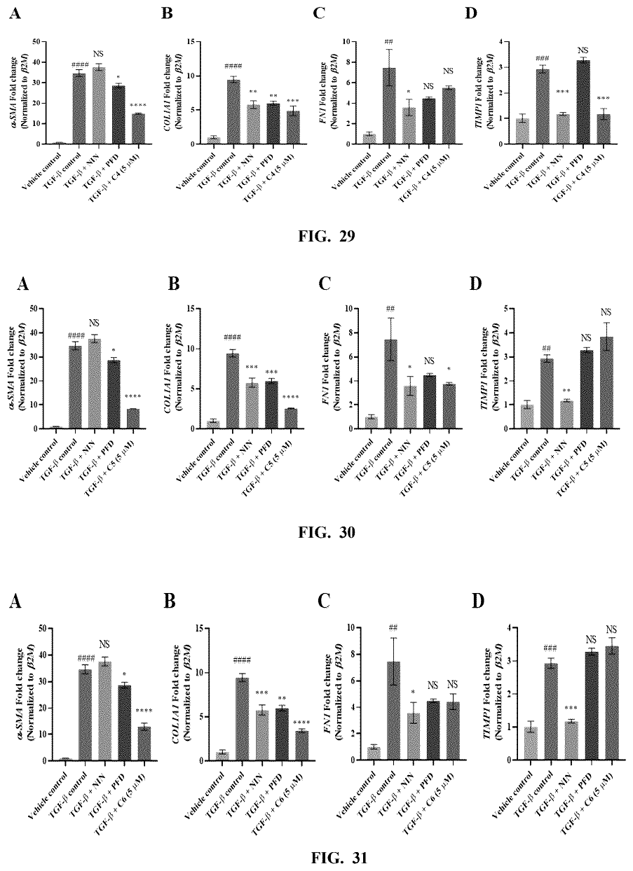

Further, we have assessed the anti-fibrotic activity of silicon-incorporated HDAC-6 inhibitor compound-4 in in vitro lung fibrosis model. Here, LL29 cells (Idiopathic lung fibrotic cells) were stimulated with TGF-β and treated with compound-C4 (5 μM) for 48 hrs and subjected to gene expression analysis. RTqPCR analysis revealed that stimulation with TGF-β significantly increased the expression of α-SMA, collagen-1 α1, FN1 and Timp-1 compared to control cells. Moreover, treatment with compound C4 significantly reduced the TGF-β induced expression of α-SMA, collagen-1 al and Timp-1 compared to TGF-β control cells. Compound C4 failed to reduce the expression of FN1 compared to TGF-β control cells (FIG. 29).

### Example 26: Assessing the Anti-Fibrotic Activity of HDAC-Inhibitor-C5 in TGF-β Induced Differentiation LL29 Cells

Further, we have assessed the anti-fibrotic activity of silicon-incorporated HDAC-6 inhibitor compound-5 in in vitro lung fibrosis model. Here, LL29 cells (Idiopathic lung fibrotic cells) were stimulated with TGF-β and treated with compound-C5 (5 μM) for 48 hrs and subjected to gene expression analysis. RTqPCR analysis revealed that stimulation with TGF-β significantly increased the expression of α-SMA, collagen-1 α1, FN1 and Timp-1 compared to control cells. Moreover, treatment with compound C5 significantly reduced the TGF-β induced expression of α-SMA, collagen-1 al and FN1 compared to TGF-β control cells. Compound C5 failed to reduce the expression of Timp-1 compared to TGF-β control cells (FIG. 30).

### Example 27: Assessing the Anti-Fibrotic Activity of HDAC-Inhibitor-C6 in TGF-β Induced Differentiation LL29 Cells

Further, we have assessed the anti-fibrotic activity of silicon-incorporated HDAC-6 inhibitor compound-6 in in vitro lung fibrosis model. Here, LL29 cells (Idiopathic lung fibrotic cells) were stimulated with TGF-β and treated with compound-C6 (5 μM) for 48 hrs and subjected to gene expression analysis. RTqPCR analysis revealed that stimulation with TGF-β significantly increased the expression of α-SMA, collagen-1 al, FN1 and Timp-1 compared to control cells. Moreover, treatment with compound C6 significantly reduced the TGF-β induced expression of α-SMA and collagen-1α1 compared to TGF-β control cells. Compound C6 failed to reduce the expression of both FN1 and Timp-1 compared to TGF-β control cells (FIG. 31).

### Example 28: Assessing the Anti-Fibrotic Activity of HDAC-Inhibitor-C7 in TGF-β Induced Differentiation LL29 Cells

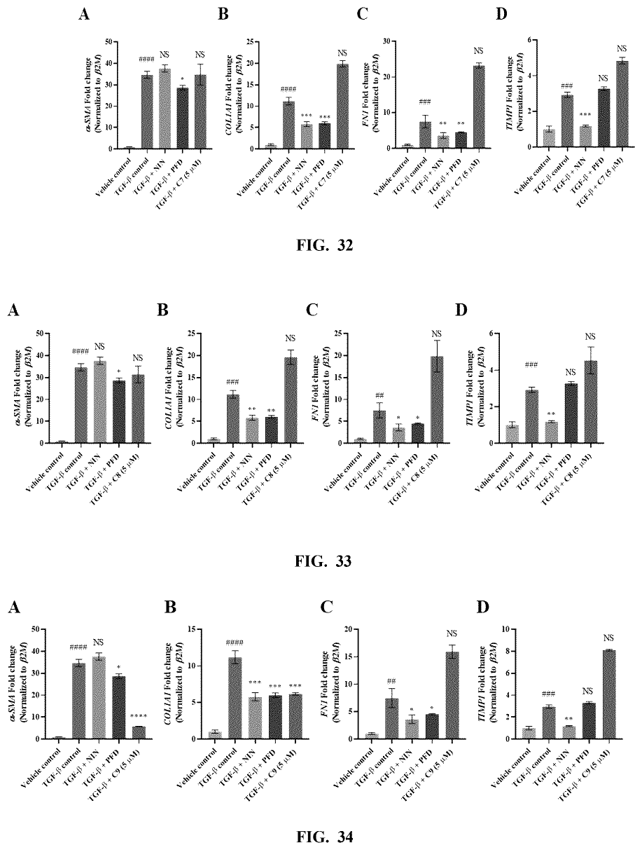

Further, we have assessed the anti-fibrotic activity of silicon-incorporated HDAC-6 inhibitor compound-7 in in vitro lung fibrosis model. Here, LL29 cells (Idiopathic lung fibrotic cells) were stimulated with TGF-β and treated with compound-C7 (5 μM) for 48 hrs and subjected to gene expression analysis. RTqPCR analysis revealed that stimulation with TGF-β significantly increased the expression of α-SMA, collagen-1 α1, FN1 and Timp-1 compared to control cells. However, treatment with compound C7 did not reduce the TGF-β induced expression of α-SMA, collagen-1 α1, FN1 and Timp-1 compared to TGF-β control cells (FIG. 32).

### Example 29: Assessing the Anti-Fibrotic Activity of HDAC-Inhibitor-C8 in TGF-β Induced Differentiation LL29 Cells

Further, we have assessed the anti-fibrotic activity of silicon-incorporated HDAC-6 inhibitor compound-8 in in vitro lung fibrosis model. Here, LL29 cells (Idiopathic lung fibrotic cells) were stimulated with TGF-β and treated with compound-C8 (5 μM) for 48 hrs and subjected to gene expression analysis. RTqPCR analysis revealed that stimulation with TGF-β significantly increased the expression of α-SMA, collagen-1 α1, FN1 and Timp-1 compared to control cells. However, treatment with compound C8 did not reduce the TGF-β induced expression of α-SMA, collagen-1α1, FN1 and Timp-1 compared to TGF-β control cells (FIG. 33).

### Example 30: Assessing the Anti-Fibrotic Activity of HDAC-Inhibitor-C9 in TGF-β Induced Differentiation LL29 Cells

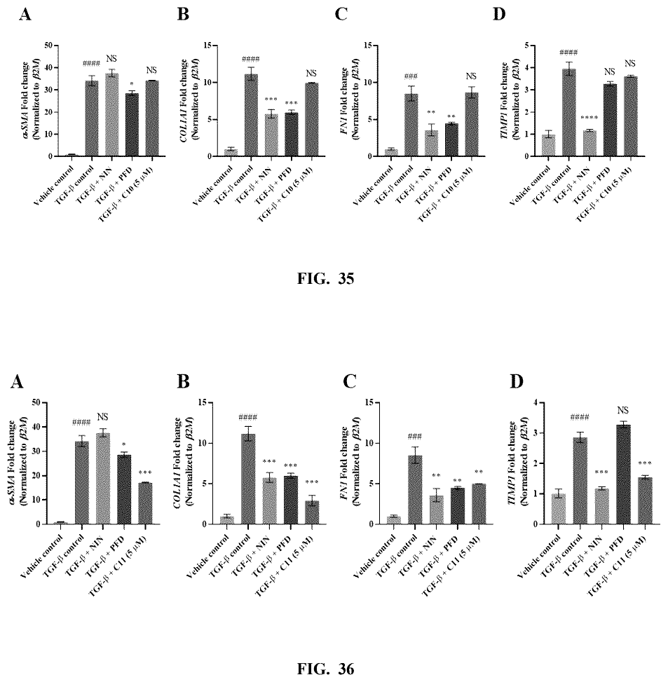

Further, we have assessed the anti-fibrotic activity of silicon-incorporated HDAC-6 inhibitor compound-9 in in vitro lung fibrosis model. Here, LL29 cells (Idiopathic lung fibrotic cells) were stimulated with TGF-β and treated with compound-C9 (5 μM) for 48 hrs and subjected to gene expression analysis. RTqPCR analysis revealed that stimulation with TGF-β significantly increased the expression of α-SMA, collagen-1 α1, FN1 and Timp-1 compared to control cells. Moreover, treatment with compound C9 significantly reduced the TGF-β induced expression of α-SMA and collagen-1α1 expression compared to TGF-β control cells. Compound C9 failed to reduce the expression of both FN1 and Timp-1 compared to TGF-β control cells (FIG. 34).

### Example 31: Assessing the Anti-Fibrotic Activity of HDAC-Inhibitor-C10 in TGF-β Induced Differentiation LL29 Cells

Further, we have assessed the anti-fibrotic activity of silicon-incorporated HDAC-6 inhibitor compound-10 in in vitro lung fibrosis model. Here, LL29 cells (Idiopathic lung fibrotic cells) were stimulated with TGF-β and treated with compound-C10 (5 μM) for 48 hrs and subjected to gene expression analysis. RTqPCR analysis revealed that stimulation with TGF-β significantly increased the expression of α-SMA, collagen-1 α1, FN1 and Timp-1 compared to control cells. However, treatment with compound C10 did not reduce the TGF-β induced expression of α-SMA, collagen-1α1, FN1 and Timp-1 compared to TGF-β control cells (FIG. 35).

### Example 32: Assessing the Anti-Fibrotic Activity of HDAC-Inhibitor-C11 in TGF-β Induced Differentiation LL29 Cells

Further, we have assessed the anti-fibrotic activity of silicon-incorporated HDAC-6 inhibitor compound-11 in in vitro lung fibrosis model. Here, LL29 cells (Idiopathic lung fibrotic cells) were stimulated with TGF-β and treated with compound-C11 (5 μM) for 48 hrs and subjected to gene expression analysis. RTqPCR analysis revealed that stimulation with TGF-β significantly increased the expression of α-SMA, collagen-1 al, FN1 and Timp-1 compared to control cells. Moreover, treatment with compound C11 significantly reduced the TGF-β induced expression of α-SMA, collagen-1 al, FN1 and Timp-1 compared to TGF-β control cells. Compound C11 showed a better reduction of α-SMA and collagen-1α1 compared to nintedanib or pirfenidone (FIG. 36).

### Example 33: Assessing the Effect of HDAC-6 Inhibitors (Compound C1, C2 and C11) on Bleomycin-Induced Histopathological Anomalies in Lungs

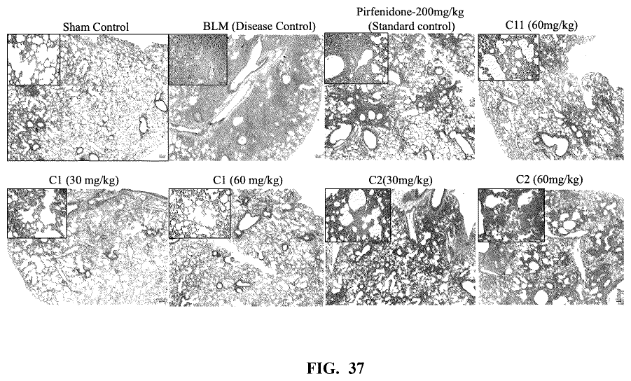

Since Compound 1 and Compound 2 have shown better anti-fibrotic activity in in vitro models, these compounds were further taken forward for in vivo assessments using a bleomycin-induced lung fibrosis model in mice. H&E analysis revealed that BLM administration markedly increased the infiltration of inflammatory cells, macrophage accumulation, alveolar cell congestions and fibrotic area. Further, treatment with C1 or C2 or C11 revealed that the aforementioned pathological abnormalities were remarkably reduced in C1 compared to BLM control or PFD control or C2 or C11 (FIG. 37).

### Example 34: Assessing the Anti-Fibrotic Activity of HDAC-6 Inhibitors (Compound C1) in Bleomycin-Induced Lung Fibrosis Model

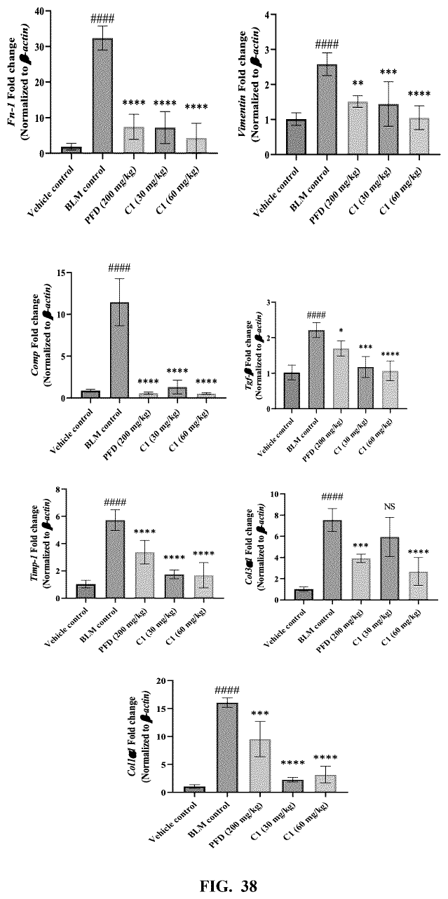

Since histopathological data reveals that, Compound C1 showed better protective effects compared to compared to BLM control or PFD control or C2 or C11, further assays were performed with C1. Next, lung specimens were collected and subjected to western blot analysis, and gene expression results demonstrated that induction with BLM significantly increased the expression of fibrotic markers such as collagen 1α1 (COL1α1), Collagen 3α1 (COL3α1), fibronectin (FN1), COMP, TGF-β, Vimentin and Timp-1, in CCL-4 control group compared to sham control. On the other hand, treatment with C1 or PFD significantly reduced the CCL4-induced elevation of Collagen 3α1 (COL3α1), Collagen 1α1 (COL1α1), fibronectin (FN1), COMP, TGF-β, Vimentin and Timp-1 expression compared to BLM control (FIG. 38).

### Example 35: Assessing the Anti-Fibrotic Activity of HDAC-6 Inhibitors (Compound C1 and C11) in Bleomycin-Induced Lung Fibrosis Model

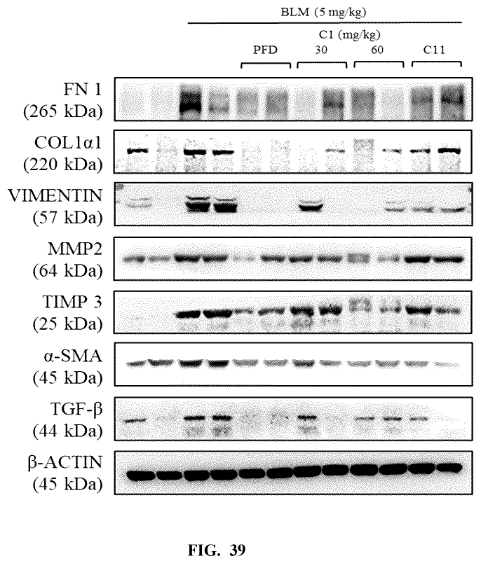

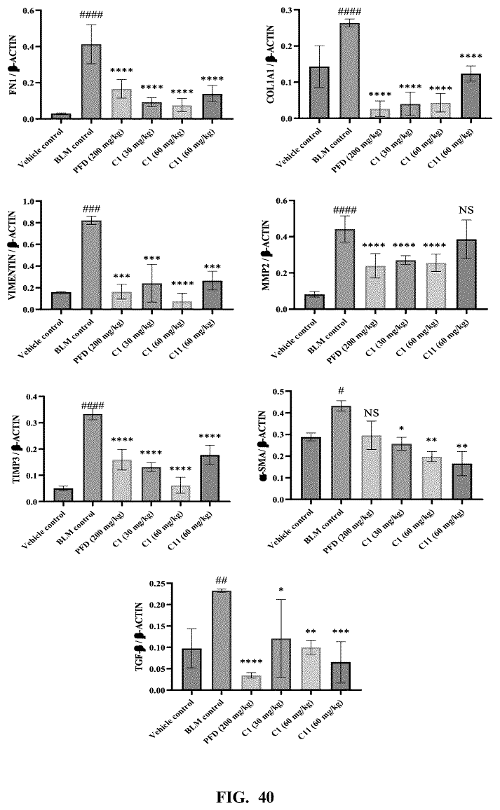

Next, lung specimens were collected and subjected to western blot analysis, and protein expression results demonstrated that induction with BLM administration significantly increased the expression of fibrotic markers such as Collagen 1α1, fibronectin (FN1), MMP-2, Vimentin, TGF-β, α-SMA and TIMP-3, in BLM control group compared to sham control. On the other hand, treatment with C1 or C11 significantly reduced the BLM-induced elevation of Collagen 1α1, fibronectin (FN1), MMP-2, Vimentin, TGF-β, α-SMA and TIMP-3 expression compared to BLM control. However, Compound C1 reduced all the markers expression better than C11. Overall this data demonstrated that compound C1 significantly reduced the fibrotic markers expression compared to C11 or PFD (FIG. 39-40).

### Advantages of the Invention

The present disclosure provides silicon-incorporated HDAC-6 inhibitor compounds of formula (I) which are useful for preventing or treating liver fibrosis.

The present disclosure also provides silicon-incorporated HDAC-6 inhibitor compounds to prevent or treat pulmonary fibrosis.

The silicon-incorporated HDAC-6 inhibitor compounds of the present disclosure are useful in treating idiopathic pulmonary fibrosis, and hepatic fibrosis, and may be useful for ski fibrosis, cardiac fibrosis, and kidney fibrosis.

We claim:

1. A silicon-incorporated HDAC 6 inhibitor compound of formula (I) 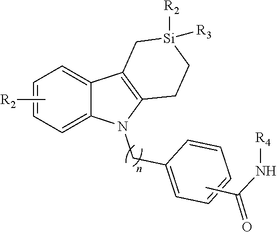
wherein,
n is selected from 0-4;
R₁ is selected from the group consisting of hydrogen, halogen, C₁-C₅ alkyl, C₁-C₅ alkoxy;
R₂ and R₅ are independently selected from the group consisting of C₁-C₃ alkyl, aryl groups;
R₄ is selected from the group consisting of hydroxy, NH₂, C₁-C₁₂ alkyl amine, substituted aryl amine and a mixture thereof.

2. The silicon-incorporated HDAC 6 inhibitor compounds of formula (I) according to claim 1, wherein the compounds are selected from the group comprising:

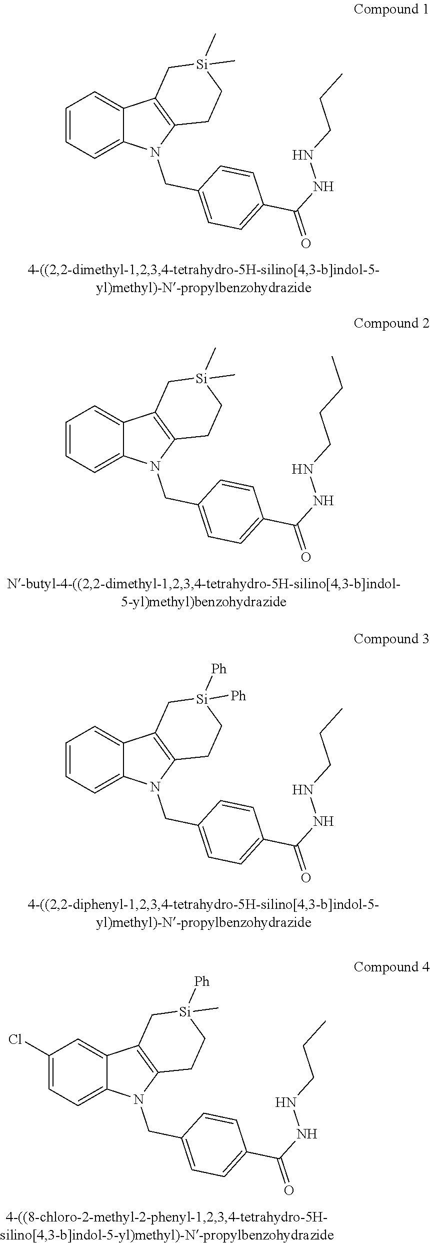 [SMILES: CCCNNC(=O)c1ccc(Cn2c3c(c4ccccc42)C[Si](C)(C)CC3)cc1 ; CCCCNNC(=O)c1ccc(Cn2c3c(c4ccccc42)C[Si](C)(C)CC3)cc1 ; CCCNNC(=O)c1ccc(Cn2c3c(c4ccccc42)C[Si](c2ccccc2)(c2ccccc2)CC3)cc1 ; CCCNNC(=O)c1ccc(Cn2c3c(c4cc(Cl)ccc42)C[Si](C)(c2ccccc2)CC3)cc1]

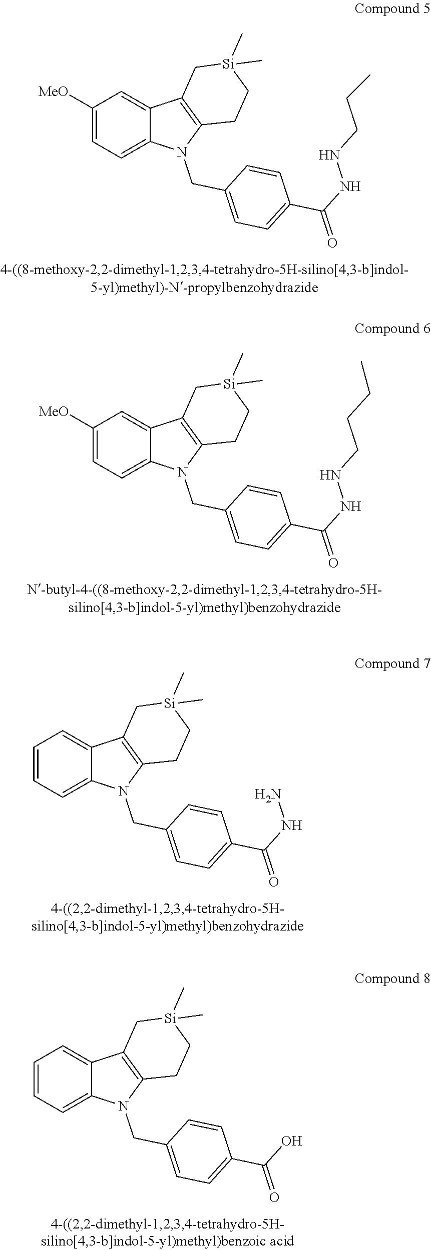 [SMILES: CCCNNC(=O)c1ccc(Cn2c3c(c4cc(OC)ccc42)C[Si](C)(C)CC3)cc1 ; CCCCNNC(=O)c1ccc(Cn2c3c(c4cc(OC)ccc42)C[Si](C)(C)CC3)cc1 ; C[Si]1(C)CCc2c(c3ccccc3n2Cc2ccc(C(=O)NN)cc2)C1 ; C[Si]1(C)CCc2c(c3ccccc3n2Cc2ccc(C(=O)O)cc2)C1]

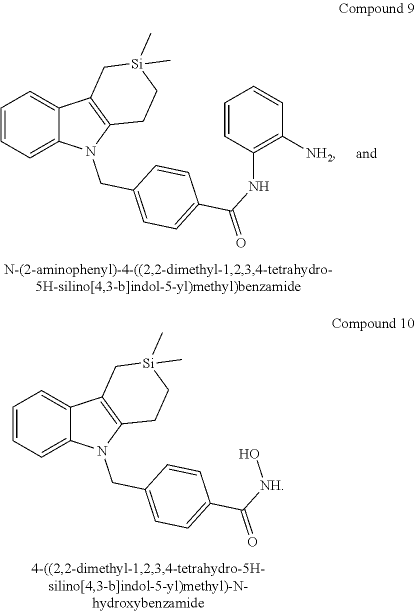 [SMILES: C[Si]1(C)CCc2c(c3ccccc3n2Cc2ccc(C(=O)Nc3ccccc3N)cc2)C1 ; C[Si]1(C)CCc2c(c3ccccc3n2Cc2ccc(C(=O)NO)cc2)C1]

3. The silicon-incorporated HDAC 6 inhibitor compounds according to claim 1, wherein the compound attenuate the extracellular matrix proteins and collagen markers expression in TGF-β stimulated LL29 cells for idiopathic pulmonary fibrosis (IPF) and liver fibrosis.

4. The silicon-incorporated HDAC-6 inhibitory compound of formula (V) according to claim 1, 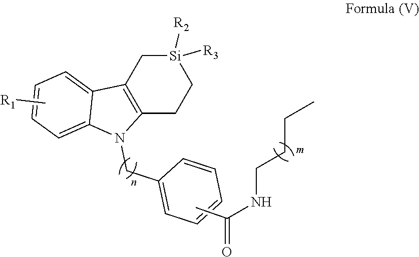
wherein,
n is 0, 1, 2, 3, 4;
m is 1-12;
R₁ is selected from the group consisting of hydrogen, halogen, C₁-C₅ alkyl, and C₁-C₅ alkoxy; and
R₂ and R₃ are independently selected from the group consisting of C₁-C₃ alkyl, aryl groups.

5. The silicon-incorporated HDAC 6 inhibitory compound of formula (VIII) according to claim 1, 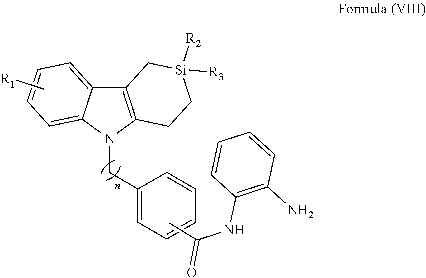
wherein,
n is 0, 1, 2, 3, 4;
R₁ is selected from the group consisting of hydrogen, halogen, C₁-C₅ alkyl, and C₁-C₅ alkoxy; and
R₂ and R₃ are independently selected from the group consisting of C₁-C₃ alkyl, aryl groups.

6. A process for the preparation of silicon-incorporated HDAC 6 inhibitor compounds of formula (V) according to claim 4, comprising the steps of:
a) reacting a compound of formula (III) with a hydrazine hydrate at a temperature of 100° C. for the period of 3 to 5 hrs to obtain a compound of formula (IV) 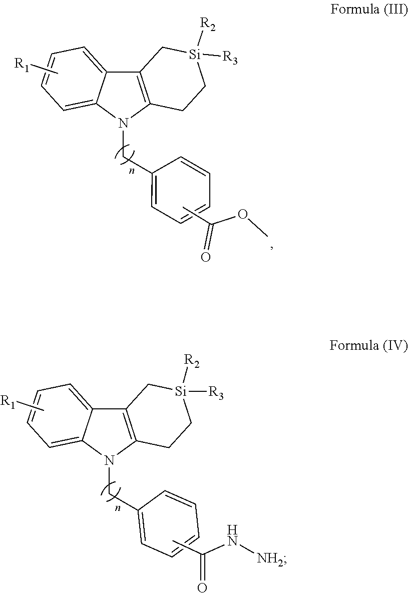
b) reacting the compound of formula (IV) obtained in step a) with a C₁-C₁₂ alkyl aldehyde at an ambient temperature period of 2 to 3 hrs followed by reacting with a reducing agent to prepare a compound of formula (V)

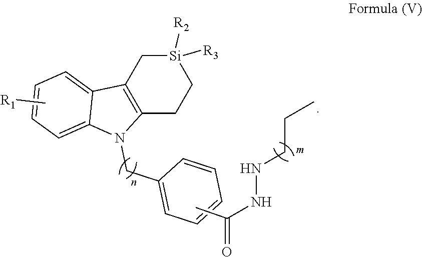

7. A process for the preparation of silicon-incorporated HDAC 6 inhibitor compounds of formula (VIII) according to claim 5, comprising the steps of:
a) reacting a compound of formula (III) with a base in presence of a polar solvent for time period of 16 hours to obtain a compound of formula (VI) 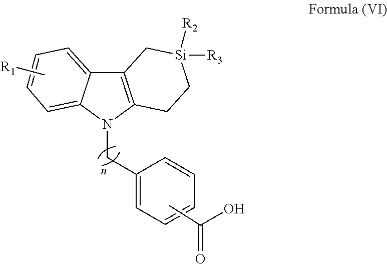
b) reacting the compound of formula (VI) obtained in step a) with a substituted aryl amine in presence coupling reagent and a base in a polar solvent for a time period of 16 hours followed by an acid treatment to obtain a compound of formula (VIII)

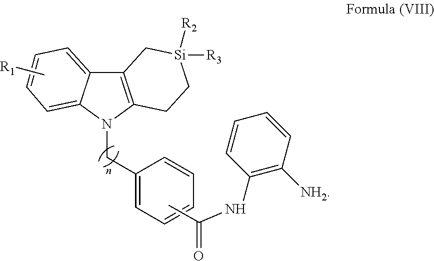

8. The process according to claim 6, wherein the C₁-C₁₂ aldehyde in step b) is selected from the group consisting of propionaldehyde, butyraldehyde, pentanal, heptanal, heptaldehyde, octanal, undecanal, dodecanal, benzaldehyde, 3-propylbenzaldehyde, and 4-propylbenzaldehyde.

9. The process according to claim 6, wherein the reducing reagent in step b) is selected from the group consisting of NaBH₄ (sodium borohydride), NaCNBH₄ (sodium cyanoborohydride), and STAB (sodium triacetoxyborohydride) or a mixture thereof.

10. The process according to claim 7, wherein the base in step a) is selected from the group consisting of NaOH (sodium hydroxide), LiOH (lithium hydroxide), and KOH (potassium hydroxide).

11. The process according to claim 7, wherein the substituted aryl amine in step b) is selected from the group consisting of aniline, 2-amino aniline, 3-amino aniline, 4-amino aniline, 2-aminophenol, 4-aminophenol, 4-nitroaniline, 2-nitroaniline 4-aminobenzonitrile, 2-aminobenzonitrile, 3-aminobenzonitrile, 3-ethylaniline, 3-fluoroaniline, 3-bromooaniline, 2,5-dibromoaniline, 2-methoxyaniline, and 4-methoxyaniline

12. The process according to claim 7, wherein the coupling agent in step b) is selected from the group consisting of hexafluorophosphate azabenzotriazole tetramethyl uronium (HATU), hydroxybenzotriazole (HOBt), 1-rthyl-3-(3-dimethylaminopropyl) carbodiimide (EDC·HCl), N,N′-dicyclohexylcarbodiimide (DCC), hexafluorophosphate benzotriazole tetramethyl uronium (HBTU), propanephosphonic acid anhydride (T₃P) or a mixture thereof.

13. The process according to claim 7, wherein the base in step b) is selected from the group consisting of diisopropylethylamine (DIPEA), triethyl amine (TEA), and 4-(N,N-dimethylamino)pyridine (DMAP) or a mixture thereof.

14. The process according to claim 7, wherein the polar solvent in step a) and step b) is selected from the group consisting of methanol, ethanol, THF (tetrahydrofuran), DMF (dimethylformamide), DCM (dichloromethane), aqueous alcohol or a mixture thereof.

15. The process according to claim 7, wherein the acid in step b) is selected from the group consisting of hydrochloric acid (HCl), trifluoroacetic acid (TFA), methanesulfonic acid (MSA), para-toluene sulfonic acid (PTSA) or a mixture thereof.

16. The silicon-incorporated HDAC 6 inhibitor compounds of formula (I) according to claim 1, wherein use of silicon incorporation pyridoindole HDAC inhibitory compounds and isomer, derivative, racemate, analogue and/or pharmaceutically acceptable salt form is for preparation of different drugs/APIs/alkaloids.

17. The silicon-incorporated HDAC 6 inhibitor compounds of formula (I) according to claim 1, wherein the silicon incorporation pyridoindole HDAC inhibitory compounds and isomer, derivative, racemate, analogue and/or pharmaceutically acceptable salt form are therapeutic agent for treating idiopathic pulmonary, hepatic, cardiac, kidney, and skin fibrosis.
